(19) United States
(12) Patent Application Publication
(10) Pub. No.: US 2023/0325973 A1
(43) Pub. Date: Oct. 12, 2023

(54) IMAGE PROCESSING METHOD, IMAGE PROCESSING DEVICE, ELECTRONIC DEVICE AND COMPUTER-READABLE STORAGE MEDIUM

(71) Applicant: BOE TECHNOLOGY GROUP CO., LTD., Beijing (CN)

(72) Inventors: Jingru WANG, Beijing (CN); Guannan CHEN, Beijing (CN); Fengshuo HU, Beijing (CN); Hanwen LIU, Beijing (CN)

(21) Appl. No.: 17/425,715

(22) PCT Filed: Oct. 30, 2020
(86) PCT No.: PCT/CN2020/125463

§ 371 Date: May 22, 2023

(51) Int. Cl. G06T 3/40; G06T 5/00

(52) U.S. Cl. CPC G06T 3/4046; G06T 2207/20016; G06T 5/001

(57) ABSTRACT

The present disclosure provides an image processing method, an image processing device, an electronic device and a computer-readable storage medium. The image processing method includes: receiving an input image; and processing the input image through a first generator to acquire an output image with definition higher than the input image. The first generator is acquired through training a to-be-trained generator using at least two discriminators. According to the embodiments of the present disclosure, the first generator for repairing the image is acquired through training with at least two discriminators, so it is able to provide the repaired image with more details, thereby to improve a repair effect.

### TECHNICAL FIELD

The present disclosure relates to the field of image processing technology, in particular to an image processing method, an image processing device, an electronic device and a computer-readable storage medium.

### BACKGROUND

Image quality repairing technology has been widely used in the field such as old picture repair and video sharpening. Currently, most of the algorithms use a super-resolution reconstruction technology to repair a low-resolution image, and usually a result is relatively smooth. In addition, in a process of repairing a face, facial components are easily deformed. Hence, there is an urgent need to improve an image repair effect.

### SUMMARY

An object of the present disclosure is to provide an image processing method, an image processing device, an electronic device and a computer-readable storage medium, so as to solve the problem in the related art where an image repairing method has a non-ideal repair effect.

In order to solve the above-mentioned technical problem, the present disclosure will be described as follows.

In a first aspect, the present disclosure provides in some embodiments an image processing method, including: receiving an input image; and processing the input image through a first generator to acquire an output image with definition higher than the input image. The first generator is acquired through training a to-be-trained generator using at least two discriminators.

In a second aspect, the present disclosure provides in some embodiments an image processing method, including: receiving an input image; detecting a face in the input image to acquire a facial image; processing the facial image using the above-mentioned method to acquire a first repair training image with definition higher than the input image; processing the input image or the input image without the facial image to acquire a second repair training image with definition higher than the input image; and fusing the first repair training image with the second repair training image to acquire a fused image with definition higher than the input image.

In a third aspect, the present disclosure provides in some embodiments an image processing device, including: a reception module configured to receive an input image; and a processing module configured to process the input image through a first generator to acquire an output image with definition higher than the input image. The first generator is acquired through training a to-be-trained generator using at least two discriminators.

In a fourth aspect, the present disclosure provides in some embodiments an image processing device, including: a reception module configured to receive an input image; a face detection module configured to detect a face in the input image to acquire a facial image; a first processing module configured to process the facial image using the above-mentioned method to acquire a first repair training image with definition higher than the input image; and a second processing module configured to process the input image or the input image without the facial image to acquire a second repair training image with definition higher than the input image, and fuse the first repair training image with the second repair training image to acquire a fused image with definition higher than the input image.

In a fifth aspect, the present disclosure provides in some embodiments an electronic device, including a processor, a memory, and a program or instruction stored in the memory and executed by the processor. The processor is configured to execute the program or instruction so as to implement the steps of the image processing method according to the first aspect or the steps of the image processing method according to the second aspect.

In a sixth aspect, the present disclosure provides in some embodiments a computer-readable storage medium storing therein a program or instruction. The program or instruction is executed by a processor so as to implement the steps of the image processing method according to the first aspect or the steps of the image processing method according to the second aspect.

According to the embodiments of the present disclosure, the first generator for repairing the image is acquired through training with at least two discriminators. As a result, it is able to provide the repaired image with more details, thereby to improve a repair effect.

### BRIEF DESCRIPTION OF THE DRAWINGS

Through reading the detailed description hereinafter, the other advantages and benefits will be apparent to a person skilled in the art. The drawings are merely used to show the preferred embodiments, but shall not be construed as limiting the present disclosure. In addition, in the drawings, same reference symbols represent same members. In these drawings,

FIG. 1 is a flow chart of an image processing method according to one embodiment of the present disclosure;

FIG. 2 is a schematic view showing a multi-scale first generator according to one embodiment of the present disclosure;

FIG. 3 is another flow chart of the image processing method according to one embodiment of the present disclosure;

FIG. 4 is yet another flow chart of the image processing method according to one embodiment of the present disclosure;

FIG. 5 is a schematic view showing a method for extracting a landmark according to one embodiment of the present disclosure;

FIG. 6 is a schematic view showing a method for generating a mask image of the landmark according to one embodiment of the present disclosure;

FIG. 7 is another schematic view showing the multi-scale first generator according to one embodiment of the present disclosure;

FIG. 8 is a schematic view showing losses of a generator according to one embodiment of the present disclosure;

FIGS. 9, 11, 13, 17, 18 and 19 are schematic views showing a method for training the generator according to one embodiment of the present disclosure;

FIGS. 10, 12 and 14 are schematic views showing a method for training a discriminator according to one embodiment of the present disclosure;

FIG. 15 is a schematic view showing a facial image according to one embodiment of the present disclosure;

FIG. 16 is a schematic view showing inputs and outputs of the generator and the discriminator according to one embodiment of the present disclosure;

FIG. 20 is another flow chart of the method for training the generator according to one embodiment of the present disclosure;

FIG. 21 is another flow chart of the method for training the discriminator according to one embodiment of the present disclosure;

FIG. 22 is another schematic view showing the inputs and outputs of the generator and the discriminator according to one embodiment of the present disclosure;

FIG. 23 is yet another flow chart of the method for training the generator according to one embodiment of the present disclosure;

FIG. 24 is yet another flow chart of the method for training the discriminator according to one embodiment of the present disclosure;

FIG. 25 is yet another flow chart of the image processing method according to one embodiment of the present disclosure;

FIG. 26 is a schematic view showing an image processing device according to one embodiment of the present disclosure; and

FIG. 27 is another schematic view showing the image processing device according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

As shown in FIG. 1, the present disclosure provides in some embodiments an image processing method, which includes the following steps.

Step 11: receiving an input image.

The input image may be a to-be-processed image, e.g., a low-definition image. The to-be-processed image may be a video frame extracted from a video, an image downloaded through a network or taken by a camera, or an image acquired in any other ways, which will not be particularly defined herein. The input image may include a plurality of noises and may be blurry, so it is necessary to denoise and/or deblur the input image through the image processing method in the embodiments of the present disclosure, thereby to increase the definition and improve the image quality. For example, when the input image is a color image, the input image may include a red (R) channel input image, a green (G) channel input image and a blue (B) channel input image.

Step 12: processing the input image through a first generator to acquire an output image with definition higher than the input image. The first generator is acquired through training a to-be-trained generator using at least two discriminators.

The first generator may be a trained neural network, and the to-be-trained generator may be a network which is established on the basis of a structure of the above-mentioned convolutional neural network and whose parameters need to be trained. For example, the first generation may be trained using the to-be-trained generator, and the to-be-trained generator may include more parameters than the first generator. For example, the parameters of the neural network may include a weight parameter of each convolutional layer in the neural network. The larger the absolute value of the weight value, the more contribution made by a neuron corresponding to the weight parameter to the output of the neural network, and the more important the neuron to the neural network. Usually, the neural network including more parameters has a higher complexity level and a larger “capacity”, i.e., the neural network is capable of completing a more complex learning task. As compared with the to-be-trained generator, the first generator has been simplified, and it has fewer parameters and a simpler network structure, so the first generator may occupy fewer resources (e.g., computing resources and storage resources) when running and thereby it may be applied to a lightweight terminal. Through the above-mentioned training mode, the first generator may learn a reasoning capability of the to-be-trained generator, thereby it may have a simple structure and a strong reasoning capability.

It should be appreciated that, in the embodiments of the present disclosure, the so-called “definition” may refer to, for example, clarity of detailed shadow textures in the image and boundaries thereof. The higher the definition, the better the visual effect. For example, when a repair training image has definition greater than the input image, it means that the input image is processed through the image processing method in the embodiments of the present disclosure, e.g., it is subjected to denoising and/or deblurring treatment, so that the acquired repair training image has the definition greater than the input image.

In the embodiments of the present disclosure, the input image may include a facial image, i.e., the first generator may be used to repair a face. Of course, the input image may also be an image of any other type.

In the embodiments of the present disclosure, because the first generator for repairing the image is acquired through training the to-be-trained generator using at least two discriminators, it is able to provide the repaired image with more details and improve a repair effect.

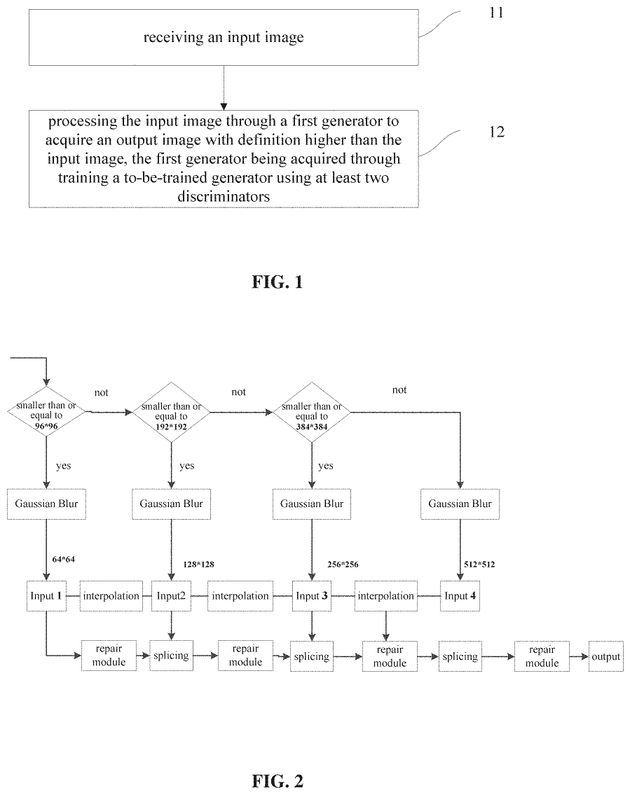

In a possible embodiment of the present disclosure, the first generator may include N repair modules each configured to denoise and/or deblur an input image with a given scale so as to improve the definition of the input image, where N is an integer greater than or equal to 2. In some embodiments of the present disclosure, N may be equal to 4. Further, as shown in FIG. 2, four repair modules include a repair module with a scale of 64*64, a repair module with a scale of 128*128, a repair module with a scale of 256*256 and a repair module with a scale of 512*512. Of course, the quantity of the repair modules may be any other value, and the scale of each repair module may not be limited to those mentioned hereinabove.

In the embodiments of the present disclosure, the scale may refer to resolution.

In a possible embodiment of the present disclosure, a network structure adopted by each repair module may be Super-Resolution Convolutional Neural Network (SRCNN) or U-Net.

In a possible embodiment of the present disclosure, the processing the input image through the first generator to acquire the output image may include: processing the input image into to-be-repaired images with N scales, the scales of a to-be-repaired image with a first scale to a to-be-repaired image with an N^{th} scale increasing gradually; and acquiring the output image through the N repair modules in accordance with the to-be-repaired images with the N scales. In a possible embodiment of the present disclosure, in two adjacent scales in the N scales, the latter may be twice the former. For example, the N scales may include a scale of 64*64, a scale of 128*128, a scale of 256*256, and a scale of 512*512.

In a possible embodiment of the present disclosure, the processing the input image into the to-be-repaired images with N scales may include: determining a scale range to which the input image belongs; processing the input image into a to-be-repaired image with a j^{th} scale corresponding to the scale range to which the input image belongs, the j^{th} scale being one of the first scale to the N^{th} scale; and upsampling and/or downsampling the to-be-repaired image with the j^{th} scale to acquire the other to-be-repaired images with N−1 scales.

In the embodiments of the present disclosure, the upsampling and downsampling treatment may each include interpolation, e.g., bicubic interpolation.

In other words, the input image may be processed into a to-be-repaired image with one of the N scales, and then the to-be-repaired image may be upsampled and/or downsampled to acquire the other to-be-repaired images with N−1 scales. Alternatively, the input image may be sampled sequentially to acquire the to-be-repaired images with N scales.

As shown in FIG. 2, at first the scale range to which the input image belongs. When the scale of the input image is smaller than or equal to 96*96, the input image may be upsampled or downsampled to acquire a to-be-repaired training image with a scale of 64*64. Next, the to-be-repaired training image with a scale of 64*64 may be upsampled to acquire to-be-repaired training images with scales of 128*128, 256*256 and 512*512 respectively. When the scale of the input image is greater than 96*96 and smaller than or equal to 192*192, the input image may be upsampled or downsampled to acquire a to-be-repaired training image with a scale of 128*128. Next, the to-be-repaired training image with the scale of 128*128 may be downsampled and upsampled to acquire to-be-repaired training images with scales of 64*64, 256*256 and 512*512 respectively. When the scale of the input image is greater than 192*192 and smaller than or equal to 384*384, the input image may be upsampled or downsampled to acquire a to-be-repaired training image with a scale of 256*256. Next, the to-be-repaired training image with the scale of 256*256 may be downsampled and upsampled to acquire to-be-repaired training images with scales of 64*64, 128*128 and 512*512 respectively. When the scale of the input image is greater than 384*384, the input image may be upsampled or downsampled to acquire a to-be-repaired training image with a scale of 512*512. Next, the to-be-repaired training image with the scale of 512*512 may be downsampled and upsampled to acquire to-be-repaired training images with scales of 64*64, 128*128 and 256*256 respectively.

Of course, it should be appreciated that, the above-mentioned numeric value for determining the scale range to which the input image belongs may be selected according to the practical need. As mentioned hereinabove, an intermediate scale between two adjacent scales in the N scales of the to-be-repaired images may be selected, e.g., an intermediate scale between two adjacent scales of 64*64 and 128*128 may be 96*96, and an intermediate scale between two adjacent scales of 128*128 and 256*256 may be 192*192, and so on. Of course, the intermediate scales shall not be limited to the above-mentioned 96*96, 192*192 and 384*384.

In the embodiments of the present disclosure, the upsampling or downsampling may be implemented through interpolation.

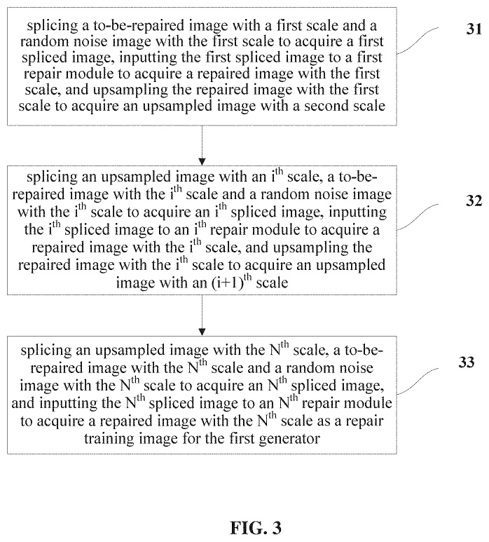

In some embodiments of the present disclosure, as shown in FIG. 3, the acquiring the output image through the N repair modules in accordance with the to-be-repaired images with the N scales may include the following steps.

Step 31: splicing a to-be-repaired image with a first scale and a random noise image with the first scale to acquire a first spliced image, inputting the first spliced image to a first repair module to acquire a repaired image with the first scale, and upsampling the repaired image with the first scale to acquire an upsampled image with a second scale.

The random noise image with the first scale may be generated randomly, or generated through upsampling or downsampling a random noise image with a same scale as the input image.

Still taking FIG. 2 as an example, after a to-be-repaired image with a scale of 64*64 (i.e., input 1 in FIG. 2) and a random noise image with the scale of 64*64 have been acquired, the to-be-repaired image with the scale of 64*64 and the random noise image with the scale of 64*64 may be spliced to acquire a first spliced image. Next, the first spliced image may be inputted to the first repair module to acquire a repaired image with the scale of 64*64. Then, the repaired image with the scale of 64*64 may be upsampled to acquire an upsampled image with a scale of 128*128.

Step 32: splicing an upsampled image with an i^{th} scale, a to-be-repaired image with the i^{th} scale and a random noise image with the i^{th} scale to acquire an i^{th} spliced image, inputting the i^{th} spliced image to an i^{th} repair module to acquire a repaired image with the i^{th} scale, and upsampling the repaired image with the i^{th} scale to acquire an upsampled image with an (i+1)^{th} scale, where i is an integer greater than or equal to 2.

The i^{th} repair module may be a repair module between the first repair module and a last repair module.

Still taking FIG. 2 as an example, for a second repair module, a to-be-repaired image with a scale of 128*128 (i.e., input 2 in FIG. 2), a random noise image with the scale of 128*128 and an upsampled image with the scale of 128*128 may be spliced to acquire a second spliced image. Next, the second spliced image may be inputted to the second repair module to acquire a repaired image with the scale of 128*128. Then, the repaired image with the scale of 128*128 may be upsampled to acquire an upsampled image with a scale of 256*256. For a third repair module, a to-be-repaired image with the scale of 256*256 (i.e., input 3 in FIG. 2), a random noise image with the scale of 256*256 and an upsampled image with the scale of 256*256 may be spliced to acquire a third spliced image. Next, the third spliced image may be inputted to the third repair module to acquire a repaired image with the scale of 256*256. Then, the repaired image with the scale of 256*256 may be upsampled to acquire an upsampled image with a scale of 512*512.

Step 33: splicing an upsampled image with the N^{th} scale, a to-be-repaired image with the N^{th} scale and a random noise image with the N^{th} scale to acquire an N^{th} spliced image, and inputting the N^{th} spliced image to an N^{th} repair module to acquire a repaired image with the N^{th} scale as a repair training image for the first generator.

Still taking FIG. 2 as an example, for the last repair module, a to-be-repaired image with a scale of 512*512 (i.e., input 4 in FIG. 2), a random noise image with the scale of 512*512 and an upsampled image with the scale of 512*512 may be spliced to acquire a fourth spliced image. Next, the fourth spliced image may be inputted to the last repair module to acquire a repaired image with the scale of 512*512 as the repair training image for the first generator.

In the embodiments of the present disclosure, when repairing the image, a random noise may be added into the first generator. This is because, when a blurred image is separately inputted to the first generator, a resultant repaired image may be smoothed excessively due to the lack of high-frequency information. When the random noise is added into an input of the first generator, the random noise may be mapped as the high-frequency information on the repaired image, so as to provide the repaired image with more details.

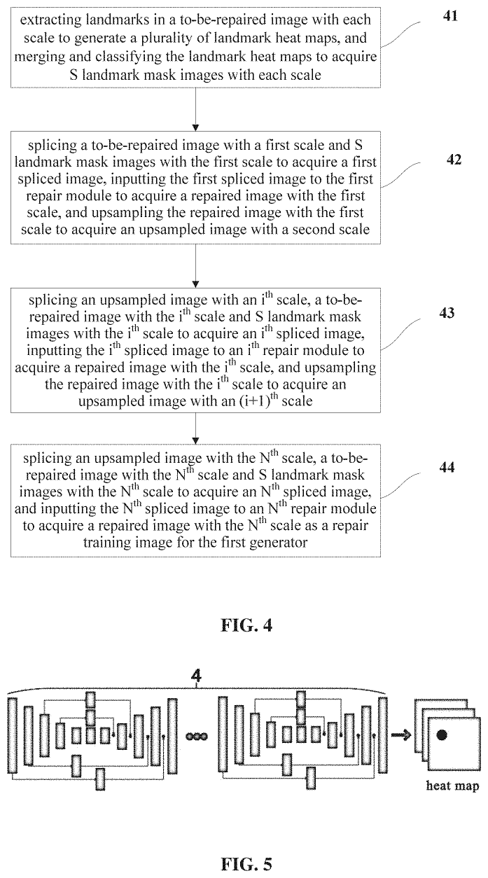

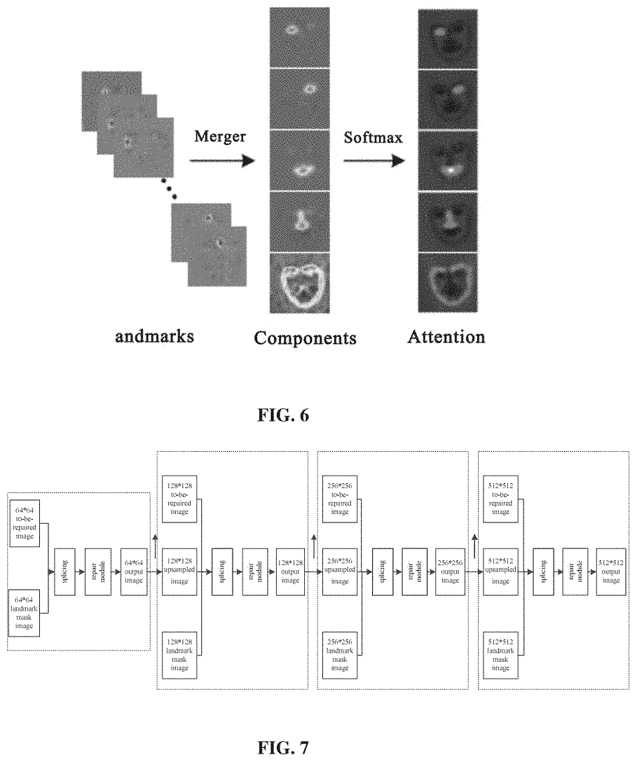

In some other embodiments of the present disclosure, as shown in FIG. 4, the acquiring the output image through the N repair module in accordance with the to-be-repaired images with N scales may include the following steps.

Step 41: extracting landmarks in a to-be-repaired image with each scale to generate a plurality of landmark heat maps, and merging and classifying the landmark heat maps to acquire S landmark mask images with each scale, where S is an integer greater than or equal to 2.

In a possible embodiment of the present disclosure, as shown in FIG. 5, a 4-stack hourglass model may be adopted to extract the landmarks in the to-be-repaired image, e.g., extract 68 landmarks in the facial image to generate 68 landmark heat maps. Each landmark heat map represents a probability that each pixel of the image is a certain landmark. Next, referring to FIG. 5, the plurality of landmark heat maps may be merged and classified (softmax) to acquire S landmark mask images corresponding to different facial components. For example, S may be 5, and the corresponding facial components may be left eye, right eye, nose, mouth and contour. Of course, in some other embodiments of the present disclosure, any other landmark extraction technique may also be adopted to extract the landmarks in the to-be-repaired image, the quantity of the extracted landmarks may not be limited to 68, and the quantity of the landmark mask images may not be limited to 5, i.e., the quantity of facial components may not be limited to 5.

Step 42: splicing a to-be-repaired image with a first scale and S landmark mask images with the first scale to acquire a first spliced image, inputting the first spliced image to the first repair module to acquire a repaired image with the first scale, and upsampling the repaired image with the first scale to acquire an upsampled image with a second scale.

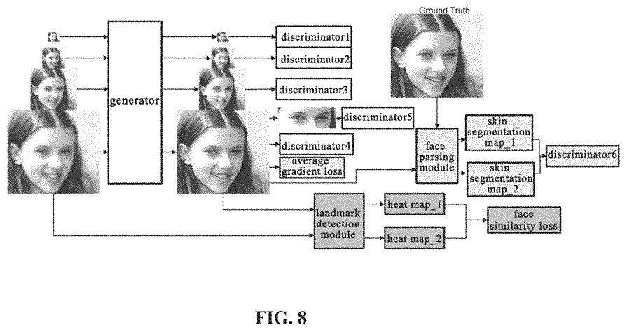

Taking FIG. 7 as an example, after the acquisition of a to-be-repaired image with a scale of 64*64 and a landmark mask image with the scale of 64*64, the to-be-repaired image with the scale of 64*64 and with landmark mask image with the scale of 64*64 may be spliced to acquire a first spliced image. Next, the first spliced image may be inputted to the first repair module to acquire a repaired image with the scale of 64*64. Then, the repaired image with the scale of 64*64 may be upsampled to acquire an upsampled image with a scale of 128*128.

Step 43: splicing an upsampled image with an i^{th} scale, a to-be-repaired image with the i^{th} scale and S landmark mask images with the i^{th} scale to acquire an i^{th} spliced image, inputting the i^{th} spliced image to an i^{th} repair module to acquire a repaired image with the i^{th} scale, and upsampling the repaired image with the i^{th} scale to acquire an upsampled image with an (i+1)th scale, where i is an integer greater than or equal to 2.

The i^{th} repair module may be a repair module between the first repair module and a last repair module.

Taking FIG. 7 as an example, for a second repair module, a to-be-repaired image with a scale of 128*128, a landmark mask image with the scale of 128*128 and an upsampled image with the scale of 128*128 may be spliced to acquire a second spliced image. Next, the second spliced image may be inputted to the second repair module to acquire a repaired image with the scale of 128*128. Then, the repaired image with the scale of 128*128 may be upsampled to acquire an upsampled image with a scale of 256*256. For a third repair module, a to-be-repaired image with the scale of 256*256, a landmark mask image with the scale of 256*256 and an upsampled image with the scale of 256*256 may be spliced to acquire a third spliced image. Next, the third spliced image may be inputted to the third repair module to acquire a repaired image with the scale of 256*256. Then, the repaired image with the scale of 256*256 may be upsampled to acquire an upsampled image with a scale of 512*512.

Step 44: splicing an upsampled image with the N^{th} scale, a to-be-repaired image with the N^{th} scale and S landmark mask images with the N^{th} scale to acquire an N^{th} spliced image, and inputting the N^{th} spliced image to an N^{th} repair module to acquire a repaired image with the N^{th} scale as a repair training image for the first generator.

Still taking FIG. 7 as an example, for the last repair module, a to-be-repaired image with a scale of 512*512, a landmark mask image with the scale of 512*512 and an upsampled image with the scale of 512*512 may be spliced to acquire a fourth spliced image. Next, the fourth spliced image may be inputted to the last repair module to acquire a repaired image with the scale of 512*512 as the repair training image for the first generator.

According to the embodiments of the present disclosure, through the introduction of the face landmark heat map into the clarification of the image, it is able to relieve the deformation of the facial components while clarifying the image, thereby to improve a final image repair effect.

A method for training the first generator will be described hereinafter.

In a possible embodiment of the present disclosure, when the first generator is acquired through training the to-be-trained generator using at least two discriminators, the to-be-trained generator and the at least two discriminators may be trained alternately in accordance with a training image and an authentication image to acquire the first generator. The authentication image may have definition higher than the training image. When training the to-be-trained generator, a total loss of the to-be-trained generator may include at least one of a first loss and a total adversarial loss of the at least two discriminators.

In a possible embodiment of the present disclosure, the first generator may include N repair modules, where N is an integer greater than or equal to 2. In some embodiments of the present disclosure, N may be equal to 4. Further, as shown in FIG. 2, four repair modules include a repair module with a scale of 64*64, a repair module with a scale of 128*128, a repair module with a scale of 256*256 and a repair module with a scale of 512*512. Of course, the quantity of the repair modules may be any other value, and the scale of each repair module may not be limited to those mentioned hereinabove. The at least two discriminators may include discriminators of a first type with a structure different from N networks corresponding to the N repair modules. For example, when the first generator includes four repair modules, the at least two discriminators may include four discriminators of the first type. As shown in FIG. 8, the four discriminators of the first type may include discriminators 1, 2, 3 and 4 in FIG. 8. As compared with the first generator acquired through training the to-be-trained generator using an individual discriminator corresponding to a single scale, the first generator acquired through training the to-be-trained generator using the discriminators of the first type corresponding to a plurality of scales may output a facial image closer to a real facial image, with a better repair effect, more details and less deformation.

Procedures for training the to-be-trained generator and the at least two discriminators will be described hereinafter.

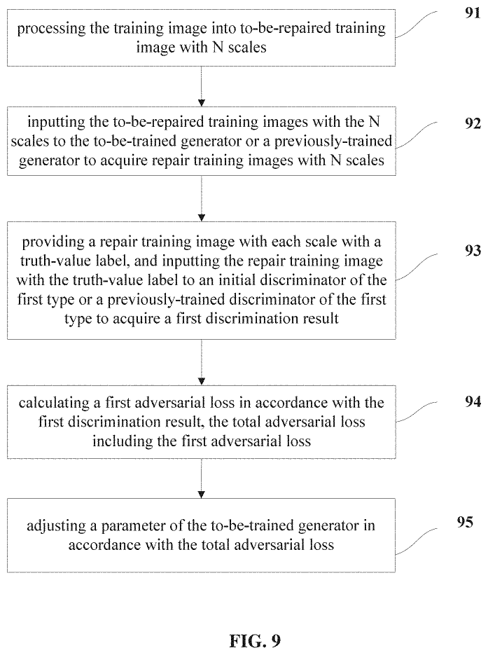

As shown in FIG. 9, the training the to-be-trained generator includes the following steps.

Step 91: processing the training image into to-be-repaired training image with N scales.

In the embodiments of the present disclosure, the training image may be processed into a to-be-repaired training image with one of the N scales, and then the to-be-repaired training image may be upsampled and/or downsampled to acquire the other N−1 to-be-repaired training images with the N−1 scales. Alternatively, the training image may also be sampled sequentially to acquire the to-be-repaired training images with the N scales.

Taking FIG. 8 as an example, the training image may be processed into four to-be-repaired training images with scales of 64*64, 128*128, 256*256 and 512*512.

Step 92: inputting the to-be-repaired training images with the N scales to the to-be-trained generator or a previously-trained generator to acquire repair training images with N scales.

In the embodiments of the present disclosure, when the to-be-trained generator is trained for the first time, the to-be-repaired training images with the N scales may be inputted to the to-be-trained generator, and when the to-be-trained generator is not trained for the first time, the to-be-repaired training images with the N scales may be inputted to the previously-trained generator.

A specific mode of processing, by the to-be-trained generator, the to-be-repaired training images with the N scales may refer to those in FIGS. 3 and 4, and thus will not be particularly defined herein.

Taking FIG. 8 as an example, the four to-be-repaired training images with the scales of 64*64, 128*128, 256*256 and 512*512 may be inputted to the to-be-trained generator or the previously-trained generator to acquire four repair training images with the scales of 64*64, 128*128, 256*256 and 512*512.

Step 93: providing a repair training image with each scale with a truth-value label, and inputting the repair training image with the truth-value label to an initial discriminator of the first type or a previously-trained discriminator of the first type to acquire a first discrimination result.

Taking FIG. 8 as an example, the repair training image with the scale of 64*64 may be provided with a truth-value label, and then inputted to the discriminator 1 to acquire a discrimination result of the discriminator 1. The repair training image with the scale of 128*128 may be provided with a truth-value label, and then inputted to the discriminator 2 to acquire a discrimination result of the discriminator 2. The repair training image with the scale of 256*256 may be provided with a truth-value label, and then inputted to the discriminator 3 to acquire a discrimination result of the discriminator 3. The repair training image with the scale of 512*512 may be provided with a truth-value label, and then inputted to the discriminator 4 to acquire a discrimination result of the discriminator 4.

Step 94: calculating a first adversarial loss in accordance with the first discrimination result, the total adversarial loss including the first adversarial loss.

In a possible embodiment of the present disclosure, the first adversarial loss may be a sum of adversarial losses corresponding to the repair training images with the scales.

Step 95: adjusting a parameter of the to-be-trained generator in accordance with the total adversarial loss.

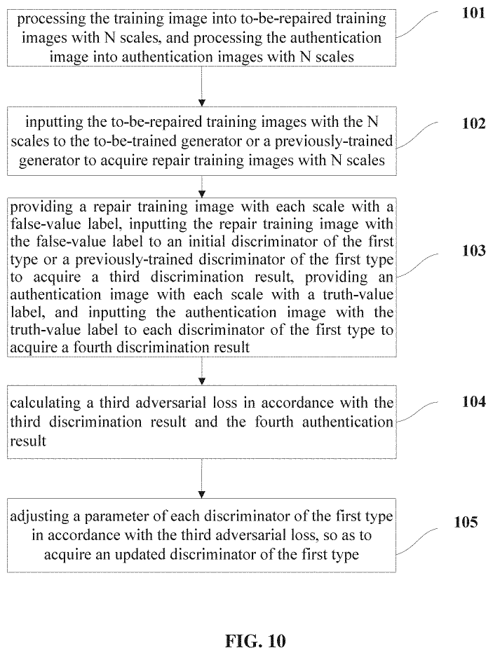

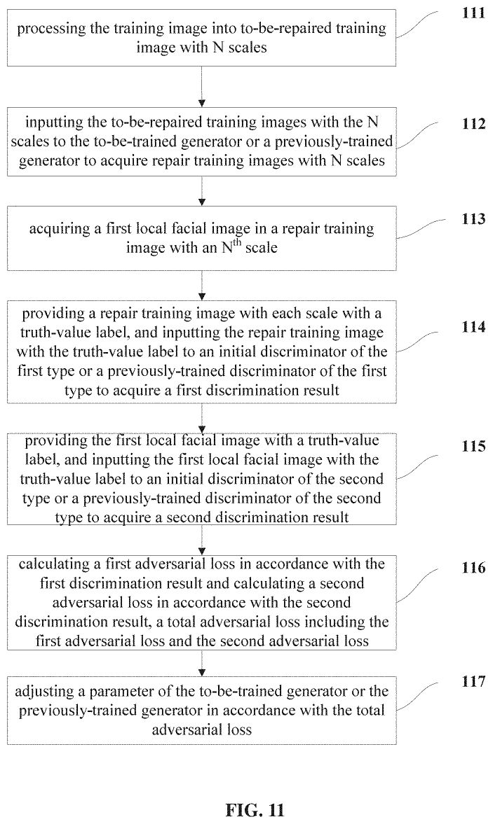

As shown in FIG. 10, the training the at least two discriminators includes the following steps.

Step 101: processing the training image into to-be-repaired training images with N scales, and processing the authentication image into authentication images with N scales.

In the embodiments of the present disclosure, the training image may be processed into a to-be-repaired training image with one of the N scales, and then the to-be-repaired training image may be upsampled and/or downsampled to acquire the other to-be-repaired training images with N−1 scales. Alternatively, the training image may be sampled sequentially to acquire the to-be-repaired training images with the N scales.

In the embodiments of the present disclosure, the authentication image may be processed into an authentication image with one of the N scales, and then the processed authentication image may be upsampled and/or downsampled to acquire the other authentication images with N−1 scales. Alternatively, the authentication image may be sampled sequentially to acquire the authentication images with the N scales.

Taking FIG. 8 as an example, the training image may be processed into four to-be-repaired training images with scales of 64*64, 128*128, 256*256 and 512*512, and the authentication image may be processed into four authentication images with scales of 64*64, 128*128, 256*256 and 512*512.

Step 102: inputting the to-be-repaired training images with the N scales to the to-be-trained generator or a previously-trained generator to acquire repair training images with N scales.

A specific mode of processing, by the to-be-trained generator, the to-be-repaired training images with the N scales may refer to those in FIGS. 3 and 4, and thus will not be particularly defined herein.

Taking FIG. 8 as an example, the four to-be-repaired training images with the scales of 64*64, 128*128, 256*256 and 512*512 may be inputted to the to-be-trained generator or the previously-trained generator to acquire four repair training images with the scales of 64*64, 128*128, 256*256 and 512*512.

Step 103: providing a repair training image with each scale with a false-value label, inputting the repair training image with the false-value label to an initial discriminator of the first type or a previously-trained discriminator of the first type to acquire a third discrimination result, providing an authentication image with each scale with a truth-value label, and inputting the authentication image with the truth-value label to each discriminator of the first type to acquire a fourth discrimination result.

Taking FIG. 8 as an example, the repair training image with the scale of 64*64 may be provided with a false-value label, and then inputted to the discriminator 1 to acquire a third discrimination result of the discriminator 1. The authentication image with the scale of 64*64 may be provided with a truth-value label, and then inputted to the discriminator 1 to acquire a fourth discrimination result of the discriminator 1. The repair training image with the scale of 128*128 may be provided with a false-value label, and then inputted to the discriminator 2 to acquire a third discrimination result of the discriminator 2. The authentication image with the scale of 128*128 may be provided with a truth-value label, and then inputted to the discriminator 2 to acquire a fourth discrimination result of the discriminator 2. The repair training image with the scale of 256*256 may be provided with a false-value label, and then inputted to the discriminator 3 to acquire a third discrimination result of the discriminator 3. The authentication image with the scale of 256*256 may be provided with a truth-value label, and then inputted to the discriminator 3 to acquire a fourth discrimination result of the discriminator 3. The repair training image with the scale of 512*512 may be provided with a false-value label, and then inputted to the discriminator 4 to acquire a third discrimination result of the discriminator 4. The authentication image with the scale of 512*512 may be provided with a truth-value label, and then inputted to the discriminator 4 to acquire a fourth discrimination result of the discriminator 4.

Step 104: calculating a third adversarial loss in accordance with the third discrimination result and the fourth authentication result.

Step 105: adjusting a parameter of each discriminator of the first type in accordance with the third adversarial loss, so as to acquire an updated discriminator of the first type.

In a possible embodiment of the present disclosure, the at least two discriminators may include a discriminator of a first type and a discriminator of a second type each having a structure different from N networks corresponding to the N repair modules. The discriminator of the second type is configured to improve the local repairing of the clarification of the face in the training image by the first generator, thereby to increase the definition of a local feature of the face in the image outputted by the first generator acquired through training.

Procedures of training the to-be-trained generator and the at least two discriminators will be described hereinafter.

As shown in FIG. 11, the training the to-be-trained generator includes the following steps.

Step 111: processing the training image into to-be-repaired training image with N scales.

In the embodiments of the present disclosure, the training image may be processed into a to-be-repaired training image with one of the N scales, and then the to-be-repaired training image may be upsampled and/or downsampled to acquire the other N−1 to-be-repaired training images with the N−1 scales. Alternatively, the training image may also be sampled sequentially to acquire the to-be-repaired training images with the N scales.

Taking FIG. 8 as an example, the training image may be processed into four to-be-repaired training images with scales of 64*64, 128*128, 256*256 and 512*512.

Step 112: inputting the to-be-repaired training images with the N scales to the to-be-trained generator or a previously-trained generator to acquire repair training images with N scales.

A specific mode of processing, by the to-be-trained generator, the to-be-repaired training images with the N scales may refer to those in FIGS. 3 and 4, and thus will not be particularly defined herein.

Taking FIG. 8 as an example, the four to-be-repaired training images with the scales of 64*64, 128*128, 256*256 and 512*512 may be inputted to the to-be-trained generator or the previously-trained generator to acquire four repair training images with the scales of 64*64, 128*128, 256*256 and 512*512.

Step 113: acquiring a first local facial image in a repair training image with an N^{th} scale.

In a possible embodiment of the present disclosure, the first local facial image may be an eye image. In the embodiments of the present disclosure, the eye image may be directly intercepted, e.g., through screenshot, from the repair training image with the N^{th} scale as the first local facial image.

Step 114: providing a repair training image with each scale with a truth-value label, and inputting the repair training image with the truth-value label to an initial discriminator of the first type or a previously-trained discriminator of the first type to acquire a first discrimination result.

Taking FIG. 8 as an example, the repair training image with the scale of 64*64 may be provided with a truth-value label, and then inputted to the discriminator 1 to acquire a first discrimination result of the discriminator 1. The repair training image with the scale of 128*128 may be provided with a truth-value label, and then inputted to the discriminator 2 to acquire a first discrimination result of the discriminator 2. The repair training image with the scale of 256*256 may be provided with a truth-value label, and then inputted to the discriminator 3 to acquire a first discrimination result of the discriminator 3. The repair training image with the scale of 512*512 may be provided with a truth-value label, and then inputted to the discriminator 4 to acquire a first discrimination result of the discriminator 4.

Step 115: providing the first local facial image with a truth-value label, and inputting the first local facial image with the truth-value label to an initial discriminator of the second type or a previously-trained discriminator of the second type to acquire a second discrimination result.

Taking FIG. 8 as an example, a discriminator 5 in FIG. 8 may be the discriminator of the second type. The first local facial image may be provided with the truth-value label, and then inputted to the discriminator 5 so as to acquire a second discrimination result of the discriminator 5.

Step 116: calculating a first adversarial loss in accordance with the first discrimination result and calculating a second adversarial loss in accordance with the second discrimination result, a total adversarial loss including the first adversarial loss and the second adversarial loss.

In a possible embodiment of the present disclosure, the first adversarial loss may be a sum of adversarial losses corresponding to the repair training images with the scales.

Step 117: adjusting a parameter of the to-be-trained generator or the previously-trained generator in accordance with the total adversarial loss.

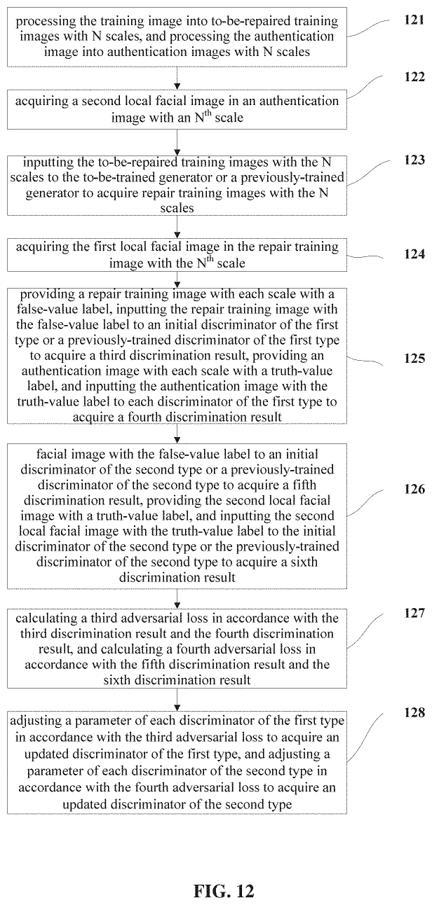

As shown in FIG. 12, the training the at least two discriminators includes the following steps.

Step 121: processing the training image into to-be-repaired training images with N scales, and processing the authentication image into authentication images with N scales.

In the embodiments of the present disclosure, the training image may be processed into a to-be-repaired training image with one of the N scales, and then the to-be-repaired training image may be upsampled and/or downsampled to acquire the other to-be-repaired training images with N−1 scales. Alternatively, the training image may be sampled sequentially to acquire the to-be-repaired training images with the N scales.

In the embodiments of the present disclosure, the authentication image may be processed into an authentication image with one of the N scales, and then the processed authentication image may be upsampled and/or downsampled to acquire the other authentication images with N−1 scales. Alternatively, the authentication image may be sampled sequentially to acquire the authentication images with the N scales.

Taking FIG. 8 as an example, the training image may be processed into four to-be-repaired training images with scales of 64*64, 128*128, 256*256 and 512*512, and the authentication image may be processed into four authentication images with scales of 64*64, 128*128, 256*256 and 512*512.

Step 122: acquiring a second local facial image in an authentication image with an N^{th} scale.

In a possible embodiment of the present disclosure, the first local facial image and the second local facial image may each be an eye image.

In the embodiments of the present disclosure, the eye image may be directly intercepted, through screenshot, from the authentication image with the N^{th} scale as the second local facial image.

Step 123: inputting the to-be-repaired training images with the N scales to the to-be-trained generator or a previously-trained generator to acquire repair training images with the N scales.

A specific mode of processing, by the to-be-trained generator, the to-be-repaired training images with the N scales may refer to those in FIGS. 3 and 4, and thus will not be particularly defined herein.

Taking FIG. 8 as an example, the four to-be-repaired training images with the scales of 64*64, 128*128, 256*256 and 512*512 may be inputted to the to-be-trained generator or the previously-trained generator to acquire four repair training images with the scales of 64*64, 128*128, 256*256 and 512*512.

Step 124: acquiring the first local facial image in the repair training image with the N^{th} scale.

In the embodiments of the present disclosure, the eye image may be directly intercepted, through screenshot, from the authentication image with the N^{th} scale as the first local facial image.

Step 125: providing a repair training image with each scale with a false-value label, inputting the repair training image with the false-value label to an initial discriminator of the first type or a previously-trained discriminator of the first type to acquire a third discrimination result, providing an authentication image with each scale with a truth-value label, and inputting the authentication image with the truth-value label to each discriminator of the first type to acquire a fourth discrimination result.

Step 126: providing the first local facial image with a false-value label, inputting the first local facial image with the false-value label to an initial discriminator of the second type or a previously-trained discriminator of the second type to acquire a fifth discrimination result, providing the second local facial image with a truth-value label, and inputting the second local facial image with the truth-value label to the initial discriminator of the second type or the previously-trained discriminator of the second type to acquire a sixth discrimination result.

Step 127: calculating a third adversarial loss in accordance with the third discrimination result and the fourth discrimination result, and calculating a fourth adversarial loss in accordance with the fifth discrimination result and the sixth discrimination result.

Step 128: adjusting a parameter of each discriminator of the first type in accordance with the third adversarial loss to acquire an updated discriminator of the first type, and adjusting a parameter of each discriminator of the second type in accordance with the fourth adversarial loss to acquire an updated discriminator of the second type.

In the embodiments of the present disclosure, an eye in a most important component of the face, and through adding the adversarial loss of the eye image, it is able to improve a training effect.

In a possible embodiment of the present disclosure, the at least two discriminators may further include X discriminators of a third type, where X is a positive integer greater than or equal to 1. Each discriminator of the third type is configured to improve the repairing of details of the facial component in the training image by the first generator. In the facial image outputted by the first generator acquired through training with the discriminator of the third type, the eye image may be clearer and have more details.

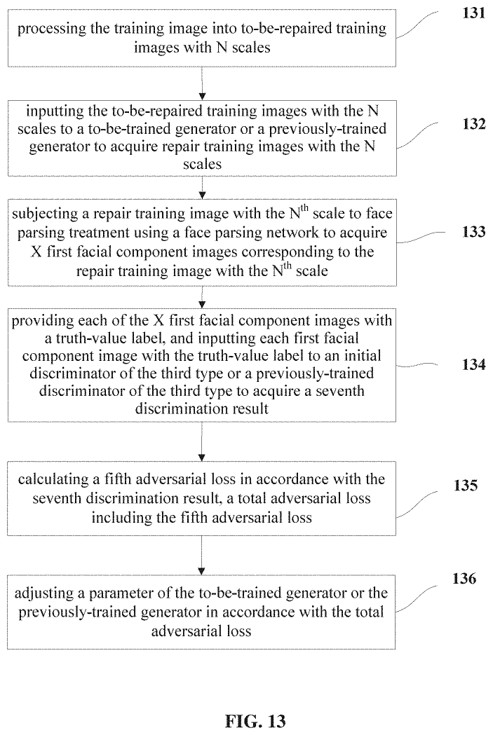

As shown in FIG. 13, the training the to-be-trained generator may further include the following steps.

Step 131: processing the training image into to-be-repaired training images with N scales.

A specific method for processing the training image into the to-be-repaired training images with the N scales may refer to that mentioned hereinabove, and thus will not be particularly defined herein.

Step 132: inputting the to-be-repaired training images with the N scales to a to-be-trained generator or a previously-trained generator to acquire repair training images with the N scales.

A procedure of processing, by the to-be-trained generator, the to-be-repaired training images with the N scales may refer to that mentioned hereinabove, and thus will not be particularly defined herein.

Step 133: subjecting a repair training image with the N^{th} scale to face parsing treatment using a face parsing network to acquire X first facial component images corresponding to the repair training image with the N^{th} scale. When X is equal to 1, the first facial component image may include one facial component, and when X is greater than 1, the X first facial component images may include different facial components.

In the embodiments of the present disclosure, the face parsing network may be a semantic segmentation network.

In the embodiments of the present disclosure, the face parsing network may be used to parse the face, and output the facial components, which include at least one of background, facial skin, left eyebrow, right eyebrow, left eye, right eye, left ear, right ear, nose, teeth, upper lip, lower lip, cloth, hair, hat, glasses and neck.

Step 134: providing each of the X first facial component images with a truth-value label, and inputting each first facial component image with the truth-value label to an initial discriminator of the third type or a previously-trained discriminator of the third type to acquire a seventh discrimination result.

Step 135: calculating a fifth adversarial loss in accordance with the seventh discrimination result, a total adversarial loss including the fifth adversarial loss.

Step 136: adjusting a parameter of the to-be-trained generator or the previously-trained generator in accordance with the total adversarial loss.

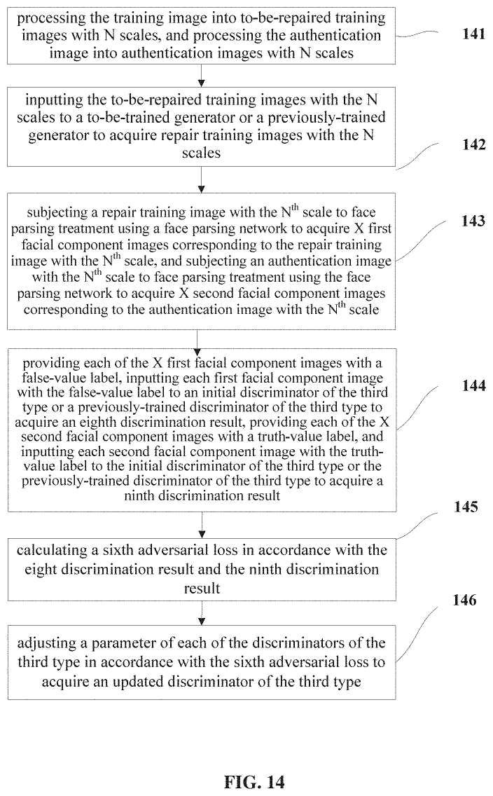

As shown in FIG. 14, the training the at least two discriminators may include the following steps.

Step 141: processing the training image into to-be-repaired training images with N scales, and processing the authentication image into authentication images with N scales.

Step 142: inputting the to-be-repaired training images with the N scales to a to-be-trained generator or a previously-trained generator to acquire repair training images with the N scales.

Step 143: subjecting a repair training image with the N^{th} scale to face parsing treatment using a face parsing network to acquire X first facial component images corresponding to the repair training image with the N^{th} scale, the X first facial component images including different facial components, and subjecting an authentication image with the N^{th} scale to face parsing treatment using the face parsing network to acquire X second facial component images corresponding to the authentication image with the N^{th} scale, the X second facial component images including different facial components.

In the embodiments of the present disclosure, the face parsing network may be a semantic segmentation network.

In the embodiments of the present disclosure, the face parsing network may be used to parse the face, and output the facial components, which include at least one of background, facial skin, left eyebrow, right eyebrow, left eye, right eye, left ear, right ear, nose, teeth, upper lip, lower lip, cloth, hair, hat, glasses and neck.

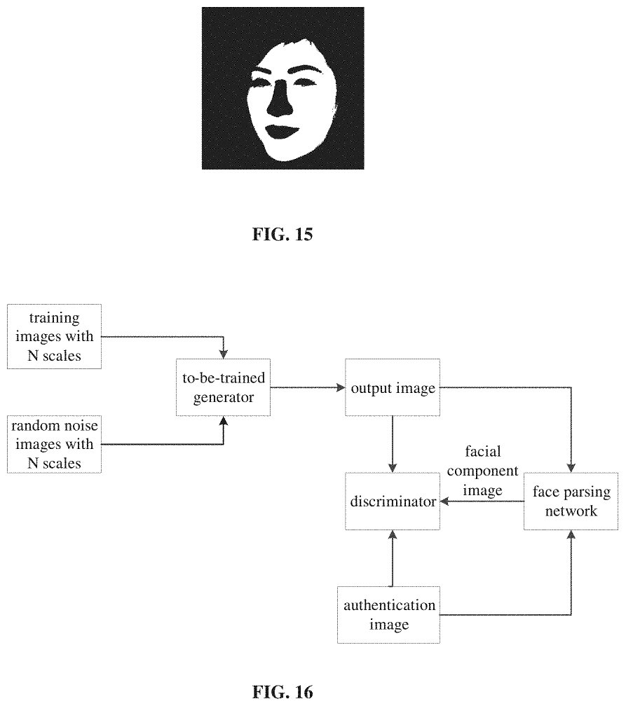

As shown in FIG. 15, X is equal to 1. Each discriminator of the third type is configured to improve the repairing of details of a facial skin in the training image by the first generator. As compared with the other training method, in the facial image outputted by the first generator acquired through training with the discriminator of the third type, a skin image may be clearer and have more details.

Step 144: providing each of the X first facial component images with a false-value label, inputting each first facial component image with the false-value label to an initial discriminator of the third type or a previously-trained discriminator of the third type to acquire an eighth discrimination result, providing each of the X second facial component images with a truth-value label, and inputting each second facial component image with the truth-value label to the initial discriminator of the third type or the previously-trained discriminator of the third type to acquire a ninth discrimination result.

Step 145: calculating a sixth adversarial loss in accordance with the eight discrimination result and the ninth discrimination result.

Step 146: adjusting a parameter of each of the discriminators of the third type in accordance with the sixth adversarial loss to acquire an updated discriminator of the third type.

FIG. 16 is a schematic view showing inputs and outputs of the to-be-trained generator and the discriminators in the embodiments of the present disclosure. As shown in FIG. 16, the inputs of the to-be-trained generator include the training images with the N scales and the random noise images with the N scales (or the landmark mask images with the N scales), and the outputs of the to-be-trained generator include the repair training images which have been repaired. The discriminators include N discriminators of the first type corresponding to the repair modules with the N scales, and X discriminators of the third type. The inputs of the discriminators include the repair training images for the to-be-trained generator, the authentication images with the N scales, the X facial component images corresponding to the authentication image with the N^{th} scale, and the X facial component images corresponding to the repair training image with the N^{th} scale.

In the embodiments of the present disclosure, the facial components, the skin and/or the hair may be extracted from the image and inputted to the discriminator to determine whether it is true or false. Hence, when repairing each facial component using the to-trained generator, there always exists an adversarial procedure. As a result, it is able to improve the capability of the generator for generating the facial components, thereby to provide more details.

In a possible embodiment of the present disclosure, the total loss of the to-be-trained generator may further include a face similarity loss.

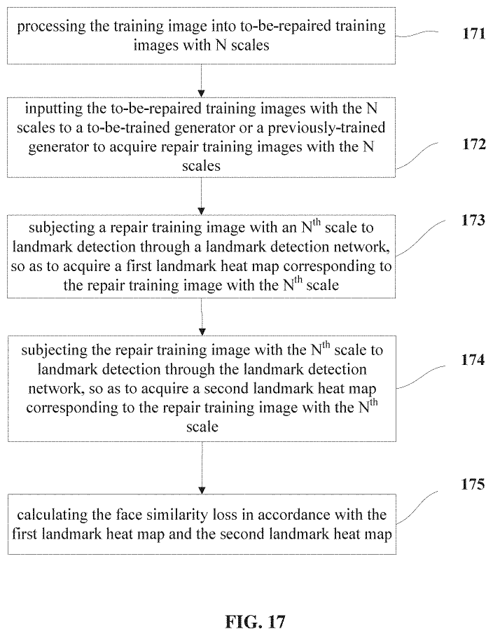

As shown in FIG. 17, the training the to-be-trained generator further includes the following steps.

Step 171: processing the training image into to-be-repaired training images with N scales.

Step 172: inputting the to-be-repaired training images with the N scales to a to-be-trained generator or a previously-trained generator to acquire repair training images with the N scales.

Step 173: subjecting a repair training image with an N^{th} scale to landmark detection through a landmark detection network, so as to acquire a first landmark heat map corresponding to the repair training image with the N^{th} scale.

Step 174: subjecting the repair training image with the N^{th} scale to landmark detection through the landmark detection network, so as to acquire a second landmark heat map corresponding to the repair training image with the N^{th} scale.

Step 175: calculating the face similarity loss in accordance with the first landmark heat map and the second landmark heat map.

In FIG. 8, a landmark detection module is just the landmark detection network, a heat map_1 is just the first landmark heat map, and a heat map_2 is just the second landmark heat map.

In a possible embodiment of the present disclosure, as shown in FIG. 5, a 4-stack hourglass model may be adopted to extract the landmarks in the to-be-repaired training image and the repair training image with the N^{th} scale, e.g., extract 68 landmarks in the facial image to generate 68 landmark heat maps. Each landmark heat map represents a probability that each pixel of the image is a certain landmark.

In a possible embodiment of the present disclosure, the total loss of the to-be-trained generator may further include an average gradient loss.

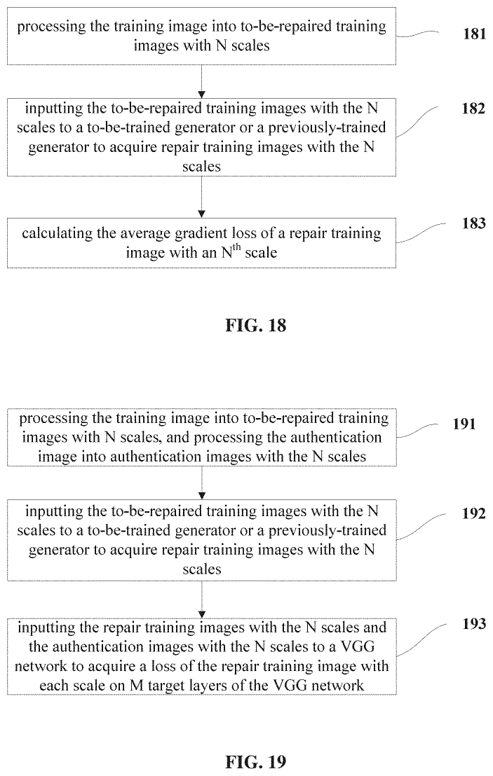

As shown in FIG. 18, the training the to-be-trained generator further includes the following steps.

Step 181: processing the training image into to-be-repaired training images with N scales.

Step 182: inputting the to-be-repaired training images with the N scales to a to-be-trained generator or a previously-trained generator to acquire repair training images with the N scales.

Step 183: calculating the average gradient loss of a repair training image with an N^{th} scale.

In a possible embodiment of the present disclosure, the average gradient loss may be calculated through an equation

$${G}^{′} = \frac{1}{m \times n} {\sum }_{i = 1}^{m} {\sum }_{j = 1}^{n} {( ( {( \frac{\partial {f}_{i , j}}{\partial {x}_{i}} )}^{2} + {( \frac{\partial {f}_{i , j}}{\partial {y}_{i}} )}^{2} ) / 2 )}^{1 / 2} ,$$

where m and n represent a width and a height of the repair training image with the N^{th} scale, f_{i,j} represents a pixel at a position (i, j) in the repair training image with the N^{th} scale, ∂f_{i,j}/∂xᵢ represents a difference between f_{i,j} and an adjacent pixel in a row direction, and ∂f_{i,j}/∂yᵢ represents a difference between f_{i,j} and an adjacent pixel in a column direction.

In a possible embodiment of the present disclosure, the first generation may include N repair modules, and the loss of the to-be-trained generator may include a first loss. In the embodiments of the present disclosure, the first loss may also be called as perceptual loss.

As shown in FIG. 19, the training the to-be-trained generator further includes the following steps.

Step 191: processing the training image into to-be-repaired training images with N scales, and processing the authentication image into authentication images with the N scales.

Step 192: inputting the to-be-repaired training images with the N scales to a to-be-trained generator or a previously-trained generator to acquire repair training images with the N scales.

Step 193: inputting the repair training images with the N scales and the authentication images with the N scales to a VGG network to acquire a loss of the repair training image with each scale on M target layers of the VGG network, where M is an integer greater than or equal to 1. The first loss includes the losses of the repair training images with the N scales on the M target layers.

In a possible embodiment of the present disclosure, the first loss may include a sum of values acquired through multiplying the loss of the repair training image with the each scale on the M target layers by a corresponding weight. The repair training images with different scales may have different weights on the target layers.

For example, the to-be-trained generator may include four repair modules with scales of 64*64, 128*128, 256*256 and 512*512, the VGG network may be a VGG19 network, and the M target layers may include layers 2-2, 3-4, 4-4 and 5-4. The first loss (i.e., the perceptual loss) L may be calculated through the following equations: L=L_{per_64}+L_{per_128}+L_{per_256}+L_{per_512}, L_{per_64}=0.4 L_{VGG}_{₂₋₂}+0.3 L_{VGG}_{₃₋₄}+0.2 L_{VGG}_{₄₋₄} 0.1 L_{VGG}_{₅₋₄}, L_{per_128}=0.3 L_{VGG}_{₂₋₂}+0.3 L_{VGG}_{₃₋₄}+0.2 L_{VGG}_{₄₋₄}+0.2 L_{VGG}_{₅₋₄} L_{per_256}=0.2 L_{VGG}_{₂₋₂} 0.2 L_{VGG}_{₃₋₄} 0.3 L_{VGG}_{₄₋₄}+0.3 L_{VGG}_{₅₋₄} and L_{per_512}=0.1 L_{VGG}_{₂₋₂} 0.2 L_{VGG}_{₃₋₄}+0.3 L_{VGG}_{₄₋₄}+0.4 L_{VGG}_{₅₋₄}. L_{per_64} represents a perceptual loss of the repair training image with the scale of 64*64, L_{per_128} represents a perceptual loss of the repair training image with the scale of 128*128, L_{per_256} represents a perceptual loss of the repair training image with the scale of 256*256, L_{per_512} represents a perceptual loss of the repair training image with the scale of 512*512, L_{VGG}_{₂₋₂} represents a perceptual loss of the repair training images with different scales on the layer 2-2, L_{VGG}_{₃₋₄} represents a perceptual loss of the repair training images with different scales on the layer 3-4, L_{VGG}_{₄₋₄} represents a perceptual loss of the repair training images with different scales on the layer 4-4, and L_{VGG}_{₅₋₄} represents a perceptual loss of the repair training images with different scales on the layer 5-4.

In the above example, the repair modules with different scales may pay attention to different contents. To be specific, the repair module with a smaller resolution may pay attention to more global content, and thereby it may correspond to a shallower VGG layer. The repair module with a larger resolution may pay attention to more local content, and thereby it may correspond to a deeper VGG layer.

Of course, in some embodiments of the present disclosure, the repair training images with different scales may have a same weight on the target layers. For example, L_{per_64}=L_{VGG}_{₂₋₂}+L_{VGG}_{₃₋₄}+L_{VGG}_{₄₋₄}+L_{VGG}_{₅₋₄}, L_{per_128}=L_{VGG}_{₂₋₂}+L_{VGG}_{₃₋₄}+L_{VGG}_{₄₋₄}+L_{VGG}_{₅₋₄}, L_{per_256}=L_{VGG}_{₂₋₂}+L_{VGG}_{₃₋₄}+L_{VGG}_{₄₋₄}+L_{VGG}_{₅₋₄} and L_{per_512}=L_{VGG}_{₂₋₂}+L_{VGG}_{₃₋₄}+L_{VGG}_{₄₋₄}+L_{VGG}_{₅₋₄}.

In a possible embodiment of the present disclosure, the first loss may further include at least one of an L1 loss, a second loss and a third loss.

When the first loss includes the L1 loss, the training the to-be-trained generator may include: processing the training image into to-be-repaired training images with N scales, and processing the authentication image into authentication images with the N scales; inputting the to-be-repaired training images with the N scales to a to-be-trained generator and a previously-trained generator to acquire repair training images with the N scales; and comparing the repair training images with the N scales with the authentication images with the N scales to acquire the L1 loss.

When the first loss includes the second loss, the training the to-be-trained generator may include: processing the training image into to-be-repaired training images with N scales, and processing the authentication image into authentication images with the N scales; inputting the to-be-repaired training images with the N scales to a to-be-trained generator and a previously-trained generator to acquire repair training images with the N scales; acquiring a first eye image in a repair training image with an N^{th} scale and a second eye image in an authentication image with the N^{th} scale; and inputting the first eye image and the second eye image to a VGG network to acquire the second loss of the first eye image on M target layers of the VGG network, where M is an integer greater than or equal to 1.

When the first loss includes the third loss, the training the to-be-trained generator may include: processing the training image into to-be-repaired training images with N scales, and processing the authentication image into authentication images with the N scales; inputting the to-be-repaired training images with the N scales to a to-be-trained generator and a previously-trained generator to acquire repair training images with the N scales; acquiring a first facial skin image in a repair training image with an N^{th} scale and a second facial skin image in an authentication image with the N^{th} scale; and inputting the first facial skin image and the second facial skin image to a VGG network to acquire the third loss of the first facial skin image on M target layers of the VGG network.

Through the second loss and the third loss, it is able improve details at an eye region and a skin region in the output image in a better manner.

In some embodiments of the present disclosure, the at least two discriminators may further include discriminators of a fourth type and discriminators of a fifth type. Each discriminator of the fourth type is configured to maintain a structural feature of the training image in the first generator. To be specific, more content information in the input image may be reserved in the output image of the first generator. Each discriminator of the fifth type is configured to improve the repairing of the details in the training image by the first generator. As compared with the other training method, the output image acquired by the first generator trained with the discriminator of the fifth type may have more details and higher definition.

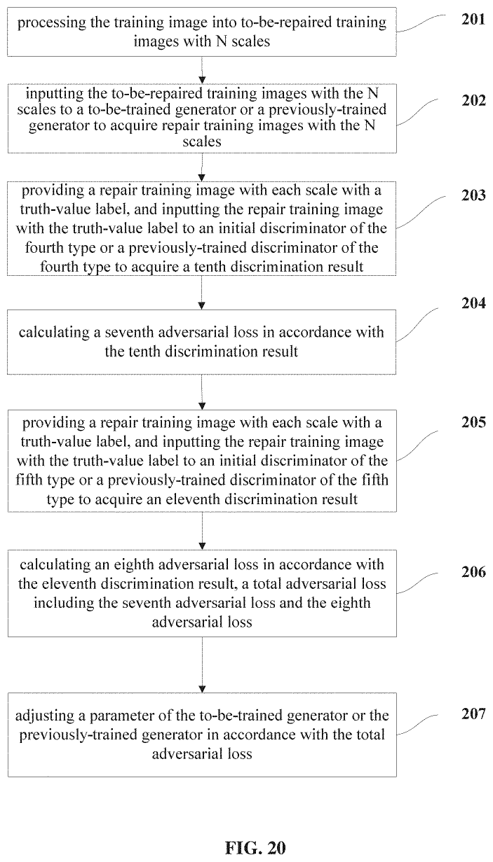

As shown in FIG. 20, the training the to-be-trained generator includes the following steps.

Step 201: processing the training image into to-be-repaired training images with N scales.

Step 202: inputting the to-be-repaired training images with the N scales to a to-be-trained generator or a previously-trained generator to acquire repair training images with the N scales.

Step 203: providing a repair training image with each scale with a truth-value label, and inputting the repair training image with the truth-value label to an initial discriminator of the fourth type or a previously-trained discriminator of the fourth type to acquire a tenth discrimination result.

Step 204: calculating a seventh adversarial loss in accordance with the tenth discrimination result.

Step 205: providing a repair training image with each scale with a truth-value label, and inputting the repair training image with the truth-value label to an initial discriminator of the fifth type or a previously-trained discriminator of the fifth type to acquire an eleventh discrimination result.

Step 206: calculating an eighth adversarial loss in accordance with the eleventh discrimination result, a total adversarial loss including the seventh adversarial loss and the eighth adversarial loss.

Step 207: adjusting a parameter of the to-be-trained generator or the previously-trained generator in accordance with the total adversarial loss.

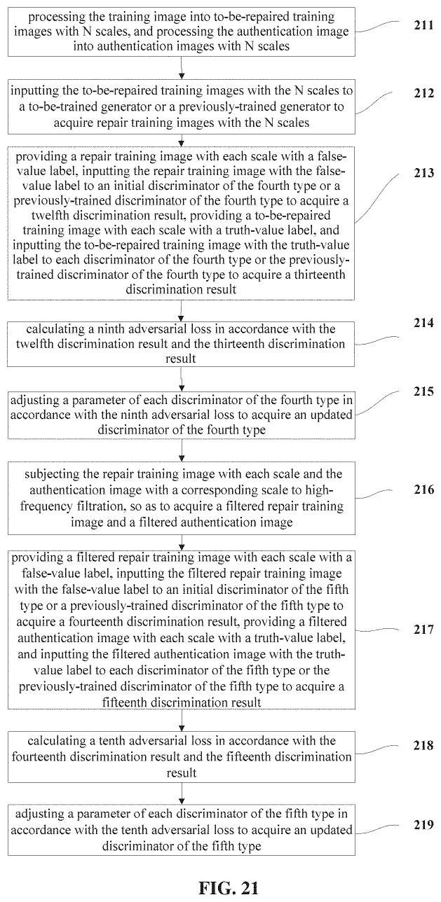

As shown in FIG. 21, the training the at least two discriminators includes the following steps.

Step 211: processing the training image into to-be-repaired training images with N scales, and processing the authentication image into authentication images with N scales.

Step 212: inputting the to-be-repaired training images with the N scales to a to-be-trained generator or a previously-trained generator to acquire repair training images with the N scales.

Step 213: providing a repair training image with each scale with a false-value label, inputting the repair training image with the false-value label to an initial discriminator of the fourth type or a previously-trained discriminator of the fourth type to acquire a twelfth discrimination result, providing a to-be-repaired training image with each scale with a truth-value label, and inputting the to-be-repaired training image with the truth-value label to each discriminator of the fourth type or the previously-trained discriminator of the fourth type to acquire a thirteenth discrimination result.

Step 214: calculating a ninth adversarial loss in accordance with the twelfth discrimination result and the thirteenth discrimination result.

Step 215: adjusting a parameter of each discriminator of the fourth type in accordance with the ninth adversarial loss to acquire an updated discriminator of the fourth type.

Step 216: subjecting the repair training image with each scale and the authentication image with a corresponding scale to high-frequency filtration, so as to acquire a filtered repair training image and a filtered authentication image.

Step 217: providing a filtered repair training image with each scale with a false-value label, inputting the filtered repair training image with the false-value label to an initial discriminator of the fifth type or a previously-trained discriminator of the fifth type to acquire a fourteenth discrimination result, providing a filtered authentication image with each scale with a truth-value label, and inputting the filtered authentication image with the truth-value label to each discriminator of the fifth type or the previously-trained discriminator of the fifth type to acquire a fifteenth discrimination result.

Step 218: calculating a tenth adversarial loss in accordance with the fourteenth discrimination result and the fifteenth discrimination result.

Step 219: adjusting a parameter of each discriminator of the fifth type in accordance with the tenth adversarial loss to acquire an updated discriminator of the fifth type.

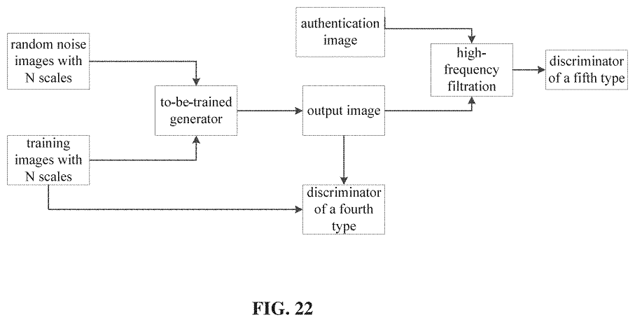

FIG. 22 is another schematic view showing inputs and outputs of the to-be-trained generator and the discriminators in the embodiments of the present disclosure. As shown in FIG. 22, the inputs of the to-be-trained generator include the training images with the N scales and the random noise images with the N scales (or the landmark mask images with the N scales), and the outputs of the to-be-trained generator include the repair training images which have been repaired. The discriminators of the fourth type include N discriminators of the first type corresponding to the repair modules with the N scales. The inputs of the discriminators of the fourth type include the repair training images for the to-be-trained generator, and the training images with the N scales. The discriminators of the fifth type include N discriminators of the first type corresponding to the repair modules with the N scales. The inputs of the discriminators of the fifth type include the images acquired after the high-frequency filtration on the repair training images for the to-be-trained generator, and the images acquired after the high-frequency filtration on the authentication images with the N scales.

In the embodiments of the present disclosure, the authentication image may be an image including a same content as the training image but having definition different from the training image, or an image including content different from the training image and having definition different from the training image.

In the embodiments of the present disclosure, two types of discriminators (the discriminator of the fourth type and the discriminator of the fifth type) have been designed. This is because, a detailed texture is high-frequency information in an image, and high-frequency information in a natural image has such a feature as to follow a specific distribution. Through the adversarial training between the discriminator of the fifth type and the generator, the generator may acquire the distribution to which the detailed texture follows, so as to map a smooth, low-resolution image to areal and natural image space with more details. The discriminator of the fourth type may judge the low-resolution image and a corresponding repair result, and retrain the image to maintain its structural feature, i.e., prevent the image from being deformed, after it has passed through the generator.

In a possible embodiment of the present disclosure, a loss function of the discriminator of the fifth type may be expressed as axV(D1, G)=log[D1(HF(y))]+ log[1−D1(HF(G(x))], and a loss function of the discriminator of the fourth type may be expressed as maxV(D2, G)=log[D2(x)]+ log[1−D2 (G(x))], where G represents the generator, D1 and D2 represent the discriminators of the fifth type and the fourth type respectively, HF represents a Gaussian high-frequency filter, x represents a training image inputted to the generator, and y represents a real high-definition authentication image.

In the embodiments of the present disclosure, the total loss of the to-be-trained generator may further include an average gradient loss, i.e., the total loss of the to-be-trained generator may be a sum of the loss of the discriminator of the fourth type, the loss of the discriminator of the fifth type and the average gradient loss.

At this time, the training the to-be-trained generator may further include: processing the training image into to-be-repaired training images with N scales; inputting the to-be-repaired training images with the N scales to a to-be-trained generator and a previously-trained generator to acquire repair training images with the N scales; and calculating the average gradient loss of a repair training image with an N^{th} scale.

In other words, a loss function of the generator may be expressed as minV(D,G)=α log[1−D1(G(x))]+β log[1−D2(x)]+γAvgG(G(x)), where α, β and γ represent weights of the losses respectively, and AvgG represents the average gradient loss. An average gradient may be used to evaluate a richness level of the detailed textures in the image. The more the details in the image, the larger the change speed of a grayscale value in a certain direction, and the larger the average gradient value.

In a possible embodiment of the present disclosure, the average gradient loss AvgG may be calculated through

$$Avg G = \frac{1}{m \times n} {\sum }_{i = 1}^{m} {\sum }_{j = 1}^{n} {( ( {( \frac{\partial {f}_{i , j}}{\partial {x}_{i}} )}^{2} + {( \frac{\partial {f}_{i , j}}{\partial {y}_{i}} )}^{2} ) / 2 )}^{1 / 2} ,$$

where m and n represent a width and a height of the repair training image with the N^{th} scale, and f_{i,j} represents a pixel at a position (i, j) in the repair training image with the N^{th} scale.

In some other embodiments of the present disclosure, the first generator may include N repair modules, and the at least two discriminators may include discriminators of a first type with a structure different from N networks corresponding to the N repair modules.

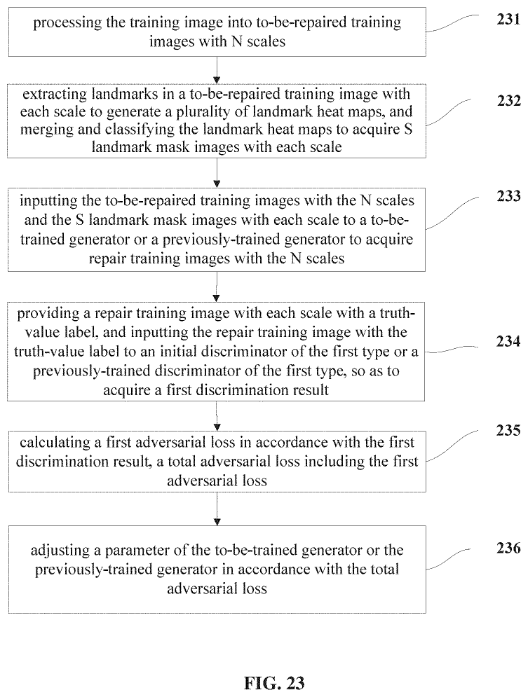

As shown in FIG. 23, the training the to-be-trained generator includes the following steps.

Step 231: processing the training image into to-be-repaired training images with N scales.

Step 232: extracting landmarks in a to-be-repaired training image with each scale to generate a plurality of landmark heat maps, and merging and classifying the landmark heat maps to acquire S landmark mask images with each scale, where S is an integer greater than or equal to 2.

Step 233: inputting the to-be-repaired training images with the N scales and the S landmark mask images with each scale to a to-be-trained generator or a previously-trained generator to acquire repair training images with the N scales.

Step 234: providing a repair training image with each scale with a truth-value label, and inputting the repair training image with the truth-value label to an initial discriminator of the first type or a previously-trained discriminator of the first type, so as to acquire a first discrimination result.

Step 235: calculating a first adversarial loss in accordance with the first discrimination result, a total adversarial loss including the first adversarial loss.

Step 236: adjusting a parameter of the to-be-trained generator or the previously-trained generator in accordance with the total adversarial loss.

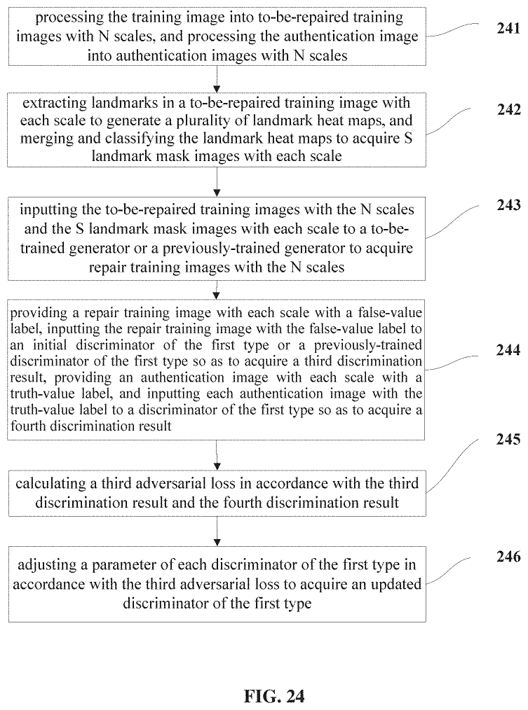

As shown in FIG. 24, the training the at least two discriminators includes the following steps.

Step 241: processing the training image into to-be-repaired training images with N scales, and processing the authentication image into authentication images with N scales.

Step 242: extracting landmarks in a to-be-repaired training image with each scale to generate a plurality of landmark heat maps, and merging and classifying the landmark heat maps to acquire S landmark mask images with each scale.

Step 243: inputting the to-be-repaired training images with the N scales and the S landmark mask images with each scale to a to-be-trained generator or a previously-trained generator to acquire repair training images with the N scales.

Step 244: providing a repair training image with each scale with a false-value label, inputting the repair training image with the false-value label to an initial discriminator of the first type or a previously-trained discriminator of the first type so as to acquire a third discrimination result, providing an authentication image with each scale with a truth-value label, and inputting each authentication image with the truth-value label to a discriminator of the first type so as to acquire a fourth discrimination result.

Step 245: calculating a third adversarial loss in accordance with the third discrimination result and the fourth discrimination result.

Step 246: adjusting a parameter of each discriminator of the first type in accordance with the third adversarial loss to acquire an updated discriminator of the first type.

In a possible embodiment of the present disclosure, the first generator may include N repair modules, and the total loss of the to-be-trained generator may be a sum of the loss of the discriminator of the first type and the first loss (the perceptual loss).

At this time, the training the to-be-trained generator may include: processing the training image into to-be-repaired training images with N scales, and processing the authentication image into authentication images with the N scales; inputting the to-be-repaired training images with the N scales to a to-be-trained generator and a previously-trained generator to acquire repair training images with the N scales; and inputting the repair training images with the N scales and the authentication images with the N scales to a VGG network to acquire a loss of the repair training image with each scale on M target layers of the VGG network, where M is an integer greater than or equal to 1. The first loss may include losses of the repair training images with the N scales on the M target layers.

In a possible embodiment of the present disclosure, the first loss may include a sum of values acquired through multiplying the loss of the repair training image with the each scale on the M target layers by a corresponding weight. The repair training images with different scales may have different weights on the target layers.

For example, the to-be-trained generator may include four repair modules with scales of 64*64, 128*128, 256*256 and 512*512, the VGG network may be a VGG19 network, and the M target layers may include layers 2-2, 3-4, 4-4 and 5-4. The first loss (i.e., the perceptual loss) L may be calculated through the following equations: L=L_{per_64}+L_{per_128}+L_{per_256}+L_{per_512}, L_{per_64}=0.4 L_{VGG}_{₂₋₂}+0.3 L_{VGG}_{₃₋₄}+0.2 L_{VGG}_{₄₋₄}+0.1 L_{VGG}_{₅₋₄}, L_{per_128}=0.3 L_{VGG}_{_{2_2}}+0.3 L_{VGG}_{₃₋₄}+0.2 L_{VGG}_{₄₋₄}+0.2 L_{VGG}_{₅₋₄}, L_{per_256}=0.2 L_{VGG}_{₂₋₂}+0.2 L_{VGG}_{₃₋₄}+0.3 L_{VGG}_{₄₋₄}+0.3 L_{VGG}_{₅₋₄}, and L_{per_512}=0.1 L_{VGG}_{₂₋₂}+0.2 L_{VGG}_{₃₋₄}+0.3 L_{VGG}_{₄₋₄}+0.4 L_{VGG}_{₅₋₄}. L_{per_64} represents a perceptual loss of the repair training image with the scale of 64*64, L_{per_128} represents a perceptual loss of the repair training image with the scale of 128*128, L_{per_256} represents a perceptual loss of the repair training image with the scale of 256*256, L_{per_512} represents a perceptual loss of the repair training image with the scale of 512*512, L_{VGG}_{₂₋₂} represents a perceptual loss of the repair training images with different scales on the layer 2-2, L_{VGG}_{₃₋₄} represents a perceptual loss of the repair training images with different scales on the layer 3-4, L_{VGG}_{₄₋₄} represents a perceptual loss of the repair training images with different scales on the layer 4-4, and L_{VGG}_{₅₋₄} represents a perceptual loss of the repair training images with different scales on the layer 5-4.

In the above example, the repair modules with different scales may pay attention to different contents. To be specific, the repair module with a smaller resolution may pay attention to more global content, and thereby it may correspond to a shallower VGG layer. The repair module with a larger resolution may pay attention to more local content, and thereby it may correspond to a deeper VGG layer.

In a possible embodiment of the present disclosure, the total loss of the to-be-trained generator may further include a per-pixel norm 2 (L2) loss. In other words, the total loss of the to-be-trained generator may be a sum of the loss of the discriminator of the first type, the first loss (the perceptual loss) and the per-pixel L2 loss.

The L2 loss may be calculated as follows. The training image may be processed into to-be-repaired training images with N scales, and the authentication image may be processed into authentication images with the N scales. Next, the to-be-repaired training images with the N scales may be inputted to a to-be-trained generator or a previously-trained generator to acquire repair training images with the N scales. Then, the repair training images with the N scales may be compared with the authentication images with the N scales to acquire the L2 loss.

In a possible embodiment of the present disclosure, the first generator may include N repair modules with a same network structure. A process for training the to-be-trained generator may include a first training stage and a second training stage. Each of the first training stage and the second training stage may include at least one process for training the to-be-trained generator. At the first training stage, when adjusting a parameter of each repair module, all the repair modules may share same parameters. At the second training stage, the parameter of each repair module may be adjusted separately.

In a possible embodiment of the present disclosure, a learning rate adopted at the first training stage (e.g., a learning rate 4=0.0001) may be greater than a learning rate adopted at the second training stage (e.g., a learning rate 4=0.00005). The lager the learning rate, the larger the training speed. At the first training stage, it is necessary to acquire the shared parameters rapidly through training, so a larger learning rate may be adopted. At the second training stage, more elaborate training needs to be performed, so a smaller learning rate may be adopted to fine-tune each repair module. This is because, the repair module with a smaller scale may pay attention to structural information about the face, and the repair module with a larger scale may pay attention to detailed information about the face. After the first training stage, the shared parameters may be decoupled, so as to enable a super-resolution module with each scale to pay more attention to the information on the scale, thereby to achieve a better detail repair effect.

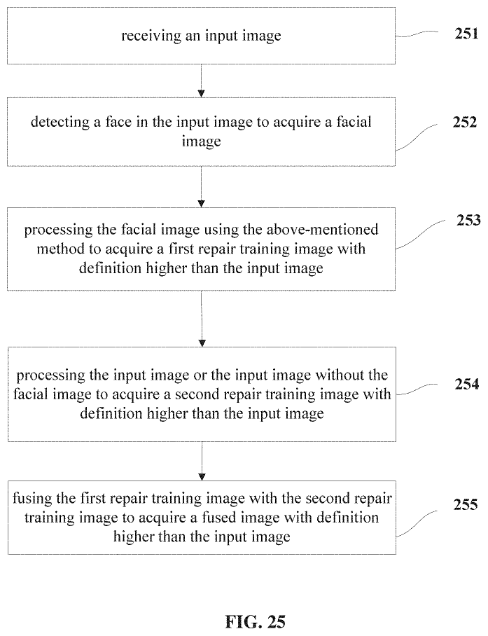

As shown in FIG. 25, the present disclosure further provides in some embodiments an image processing method, which includes the following steps.

Step 251: receiving an input image.

Step 252: detecting a face in the input image to acquire a facial image.

In a possible embodiment of the present disclosure, the detecting the face in the input image to acquire the facial image may include detecting the face in the input image to acquire a detection image, and performing standardized alignment on the detection image to acquire the facial image.

Step 253: processing the facial image using the above-mentioned method to acquire a first repair training image with definition higher than the input image.

Step 254: processing the input image or the input image without the facial image to acquire a second repair training image with definition higher than the input image.

Step 255: fusing the first repair training image with the second repair training image to acquire a fused image with definition higher than the input image.

In a possible embodiment of the present disclosure, the processing the input image or the input image without the facial image to acquire the second repair training image may include processing the input image or the input image without the facial image using the above-mentioned method to acquire the second repair training image.

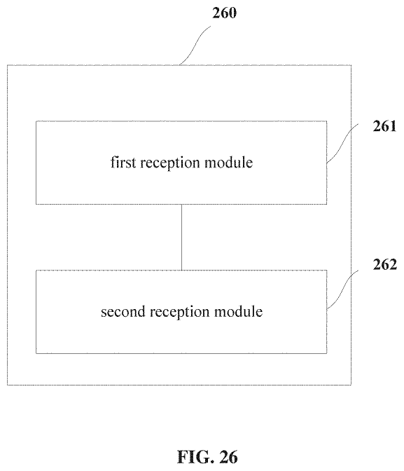

As shown in FIG. 26, the present disclosure further provides in some embodiments an image processing device 260, which includes: a reception module 261 configured to receive an input image; and a processing module 262 configured to process the input image through a first generator to acquire an output image with definition higher than the input image. The first generator is acquired through training a to-be-trained generator using at least two discriminators.

In a possible embodiment of the present disclosure, the first generator may include N repair modules, where N is an integer greater than or equal to 2. The processing module is further configured to process the input image into to-be-repaired images with N scales, the scales of a to-be-repaired image with a first scale to a to-be-repaired image with an N^{th} scale increasing gradually; and acquire the output image through the N repair modules in accordance with the to-be-repaired images with the N scales.

In a possible embodiment of the present disclosure, in two adjacent scales in the N scales, the latter may be twice the former.

In a possible embodiment of the present disclosure, the processing module is further configured to: determine a scale range to which the input image belongs; process the input image into a to-be-repaired image with a j^{th} scale corresponding to the scale range to which the input image belongs, the j^{th} scale being one of the first scale to the N^{th} scale; and upsample and/or downsample the to-be-repaired image with the j^{th} scale to acquire the other to-be-repaired images with N−1 scales.

In a possible embodiment of the present disclosure, the processing module is further configured to: splice a to-be-repaired image with the first scale and a random noise image with the first scale to acquire a first spliced image, input the first spliced image to a first repair module to acquire a repaired image with the first scale, and upsample the repaired image with the first scale to acquire an upsampled image with a second scale; splice an upsampled image with an i^{th} scale, a to-be-repaired image with the i^{th} scale and a random noise image with the i^{th} scale to acquire an i^{th} spliced image, input the i^{th} spliced image to an i^{th} repair module to acquire a repaired image with the i^{th} scale, and upsample the repaired image with the i^{th} scale to acquire an upsampled image with an (i+1)th scale, where i is an integer greater than or equal to 2; and splice an upsampled image with the N^{th} scale, a to-be-repaired image with the N^{th} scale and a random noise image with the N^{th} scale to acquire an N^{th} spliced image, and input the N^{th} spliced image to an N^{th} repair module to acquire a repaired image with the N^{th} scale as an output image of the first generator.

In a possible embodiment of the present disclosure, the processing module is further configured to: extract landmarks in a to-be-repaired image with each scale to generate a plurality of landmark heat maps, and merge and classify the landmark heat maps to acquire S landmark mask images with each scale, where S is an integer greater than or equal to 2; splice a to-be-repaired image with the first scale and S landmark mask images with the first scale to acquire a first spliced image, input the first spliced image to the first repair module to acquire a repaired image with the first scale, and upsample the repaired image with the first scale to acquire an upsampled image with a second scale; splice an upsampled image with an i^{th} scale, a to-be-repaired image with the i^{th} scale and S landmark mask images with the i^{th} scale to acquire an i^{th} spliced image, input the i^{th} spliced image to an i^{th} repair module to acquire a repaired image with the i^{th} scale, and upsample the repaired image with the i^{th} scale to acquire an upsampled image with an (i+1)th scale, where i is an integer greater than or equal to 2; and splice an upsampled image with the N^{th} scale, a to-be-repaired image with the N^{th} scale and S landmark mask images with the N^{th} scale to acquire an N^{th} spliced image, and input the N^{th} spliced image to an N^{th} repair module to acquire a repaired image with the N^{th} scale as an output image of the first generator.

In a possible embodiment of the present disclosure, the landmarks in the to-be-repaired image may be extracted through a 4-stack hourglass model.

In a possible embodiment of the present disclosure, the device may further include a training module configured to train the to-be-trained generator and the at least two discriminators alternately in accordance with a training image and an authentication image to acquire the first generator. The authentication image may have definition higher than the training image. When training the to-be-trained generator, a total loss of the to-be-trained generator may include at least one of a first loss and a total adversarial loss of the at least two discriminators.

In a possible embodiment of the present disclosure, the first generator may include N repair modules, where N is an integer greater than or equal to 2. The at least two discriminators may include discriminators of a first type with a structure different from N networks corresponding to the N repair modules, and discriminators of a second type configured to improve the local repairing of the definition of a face in the training image by the first generator.

The training module may include a first training sub-module. The first training sub-module is configured to train the to-be-trained generator, and when training the to-be-trained generator, the first training sub-module is further configured to: process the training image into to-be-repaired training image with N scales; input the to-be-repaired training images with the N scales to the to-be-trained generator or a previously-trained generator to acquire repair training images with the N scales; acquire a first local facial image in a repair training image with an N^{th} scale; provide a repair training image with each scale with a truth-value label, and input the repair training image with the truth-value label to an initial discriminator of the first type or a previously-trained discriminator of the first type to acquire a first discrimination result; provide the first local facial image with a truth-value label, and input the first local facial image with the truth-value label to an initial discriminator of the second type or a previously-trained discriminator of the second type to acquire a second discrimination result; calculate a first adversarial loss in accordance with the first discrimination result and calculate a second adversarial loss in accordance with the second discrimination result, a total adversarial loss including the first adversarial loss and the second adversarial loss; and adjust a parameter of the to-be-trained generator or the previously-trained generator in accordance with the total adversarial loss.

The first training sub-module is configured to train the at least two discriminators, and when the first training sub-module is further configured to: process the training image into to-be-repaired training images with N scales, and process the authentication image into authentication images with N scales; acquire a second local facial image in an authentication image with an N^{th} scale; input the to-be-repaired training images with the N scales to the to-be-trained generator or the previously-trained generator to acquire repair training images with the N scales; acquire the first local facial image in the repair training image with the N^{th} scale; provide a repair training image with each scale with a false-value label, input the repair training image with the false-value label to the initial discriminator of the first type or the previously-trained discriminator of the first type to acquire a third discrimination result, provide an authentication image with each scale with a truth-value label, and input the authentication image with the truth-value label to each discriminator of the first type to acquire a fourth discrimination result; provide the first local facial image with a false-value label, input the first local facial image with the false-value label to an initial discriminator of the second type or a previously-trained discriminator of the second type to acquire a fifth discrimination result, provide the second local facial image with a truth-value label, and input the second local facial image with the truth-value label to the initial discriminator of the second type or the previously-trained discriminator of the second type to acquire a sixth discrimination result; calculate a third adversarial loss in accordance with the third discrimination result and the fourth discrimination result, and calculate a fourth adversarial loss in accordance with the fifth discrimination result and the sixth discrimination result; and adjust a parameter of each discriminator of the first type in accordance with the third adversarial loss to acquire an updated discriminator of the first type, and adjust a parameter of each discriminator of the second type in accordance with the fourth adversarial loss to acquire an updated discriminator of the second type.

In a possible embodiment of the present disclosure, the first local facial image and the second local facial image may each be an eye image.

In a possible embodiment of the present disclosure, the at least two discriminators may further include X discriminators of a third type, where X is a positive integer greater than or equal to 1, and each discriminator of the third type is configured to improve the repairing of details of a facial component in the training image by the first generator.

In a possible embodiment of the present disclosure, the first training sub-module is configured to train the to-be-trained generator. When training the to-be-trained generator, the first training sub-module is further configured to: process the training image into to-be-repaired training images with N scales; input the to-be-repaired training images with the N scales to the to-be-trained generator or a previously-trained generator to acquire repair training images with the N scales; subject a repair training image with an N^{th} scale to face parsing treatment using a face parsing network to acquire X first facial component images corresponding to the repair training image with the N^{th} scale, the first facial component image including one facial component when X is equal to 1 and the X first facial component images including different facial components when X is greater than 1; provide each of the X first facial component images with a truth-value label, and input each first facial component image with the truth-value label to an initial discriminator of the third type or a previously-trained discriminator of the third type to acquire a seventh discrimination result; and calculate a fifth adversarial loss in accordance with the seventh discrimination result, a total adversarial loss including the fifth adversarial loss.

The first training sub-module is configured to train the at least two discriminators, and when training the at least two discriminators, the first training sub-module is further configured to: process the training image into to-be-repaired training images with N scales, and process the authentication image into authentication images with N scales; input the to-be-repaired training images with the N scales to the to-be-trained generator or a previously-trained generator to acquire repair training images with the N scales; subject a repair training image with an N^{th} scale to face parsing treatment using a face parsing network to acquire X first facial component images corresponding to the repair training image with the N^{th} scale, the X first facial component images including different facial components, and subject an authentication image with the N^{th} scale to face parsing treatment using the face parsing network to acquire X second facial component images corresponding to the authentication image with the N^{th} scale, the X second facial component images including different facial components; provide each of the X first facial component images with a false-value label, input each first facial component image with the false-value label to an initial discriminator of the third type or a previously-trained discriminator of the third type to acquire an eighth discrimination result, provide each of the X second facial component images with a truth-value label, and input each second facial component image with the truth-value label to the initial discriminator of the third type or the previously-trained discriminator of the third type to acquire a ninth discrimination result; calculate a sixth adversarial loss in accordance with the eight discrimination result and the ninth discrimination result; and adjust a parameter of each of the discriminators of the third type in accordance with the sixth adversarial loss to acquire an updated discriminator of the third type.

In a possible embodiment of the present disclosure, the face parsing network may be a semantic segmentation network.

In a possible embodiment of the present disclosure, X may be equal to 1, and the discriminator of the third type is configured to improve the repairing of details of a facial skin in the training image by the first generator.

In a possible embodiment of the present disclosure, the total loss of the to-be-trained generator may further include a face similarity loss. The first training sub-module is configured to train the to-be-trained generator, and when training the to-be-trained generator, the first training sub-module is further configured to: process the training image into to-be-repaired training images with N scales; input the to-be-repaired training images with the N scales to a to-be-trained generator or a previously-trained generator to acquire repair training images with the N scales; subject a repair training image with an N^{th} scale to landmark detection through a landmark detection network, so as to acquire a first landmark heat map corresponding to the repair training image with the N^{th} scale; subject the repair training image with the N^{th} scale to landmark detection through the landmark detection network, so as to acquire a second landmark heat map corresponding to the repair training image with the N^{th} scale; and calculate the face similarity loss in accordance with the first landmark heat map and the second landmark heat map.

In a possible embodiment of the present disclosure, the total loss of the to-be-trained generator may further include an average gradient loss. The first training sub-module is configured to train the to-be-trained generator, and when training the to-be-trained generator, the first training sub-module is further configured to: process the training image into to-be-repaired training images with N scales; input the to-be-repaired training images with the N scales to a to-be-trained generator or a previously-trained generator to acquire repair training images with the N scales; and calculate the average gradient loss of a repair training image with an N^{th} scale.

In a possible embodiment of the present disclosure, the first generator may include N repair modules having a same network structure, where N is an integer greater than or equal to 2. A process for training the to-be-trained generator may include a first training stage and a second training stage. Each of the first training stage and the second training stage may include at least one process for training the to-be-trained generator. At the first training stage, when adjusting a parameter of each repair module, all the repair modules may share same parameters. At the second training stage, the parameter of each repair module may be adjusted separately.

In a possible embodiment of the present disclosure, a learning rate adopted at the first training stage may be greater than a learning rate adopted at the second training stage.

In a possible embodiment of the present disclosure, the at least two discriminators may include discriminators of a fourth type and discriminators of a fifth type. Each discriminator of the fourth type is configured to maintain a structural feature of the training image in the first generator, and each discriminator of the fifth type is configured to improve the repairing of details of the training image by the first generator.

In a possible embodiment of the present disclosure, the training module may further include a second training sub-module. The second training sub-module is configured to train the to-be-trained generator, and when training the to-be-trained generator, the second training sub-module is further configured to: process the training image into to-be-repaired training images with N scales; input the to-be-repaired training images with the N scales to a to-be-trained generator or a previously-trained generator to acquire repair training images with the N scales; provide a repair training image with each scale with a truth-value label, and input the repair training image with the truth-value label to an initial discriminator of the fourth type or a previously-trained discriminator of the fourth type to acquire a tenth discrimination result; calculate a seventh adversarial loss in accordance with the tenth discrimination result; provide a repair training image with each scale with a truth-value label, and input the repair training image with the truth-value label to an initial discriminator of the fifth type or a previously-trained discriminator of the fifth type to acquire an eleventh discrimination result; calculate an eighth adversarial loss in accordance with the eleventh discrimination result, a total adversarial loss including the seventh adversarial loss and the eighth adversarial loss; and adjust a parameter of the to-be-trained generator or the previously-trained generator in accordance with the total adversarial loss.

The second training sub-module is configured to train the at least two discriminators, and when training the at least two discriminators, the second training sub-module is further configured to: process the training image into to-be-repaired training images with N scales, and process the authentication image into authentication images with N scales; input the to-be-repaired training images with the N scales to a to-be-trained generator or a previously-trained generator to acquire repair training images with the N scales; provide a repair training image with each scale with a false-value label, input the repair training image with the false-value label to an initial discriminator of the fourth type or a previously-trained discriminator of the fourth type to acquire a twelfth discrimination result, provide a to-be-repaired training image with each scale with a truth-value label, and input the to-be-repaired training image with the truth-value label to each discriminator of the fourth type or the previously-trained discriminator of the fourth type to acquire a thirteenth discrimination result; calculate a ninth adversarial loss in accordance with the twelfth discrimination result and the thirteenth discrimination result; adjust a parameter of each discriminator of the fourth type in accordance with the ninth adversarial loss to acquire an updated discriminator of the fourth type; subject the repair training image with each scale and the authentication image with a corresponding scale to high-frequency filtration, so as to acquire a filtered repair training image and a filtered authentication image; provide a filtered repair training image with each scale with a false-value label, input the filtered repair training image with the false-value label to an initial discriminator of the fifth type or a previously-trained discriminator of the fifth type to acquire a fourteenth discrimination result, provide a filtered authentication image with each scale with a truth-value label, and input the filtered authentication image with the truth-value label to each discriminator of the fifth type or the previously-trained discriminator of the fifth type to acquire a fifteenth discrimination result; calculate a tenth adversarial loss in accordance with the fourteenth discrimination result and the fifteenth discrimination result; and adjust a parameter of each discriminator of the fifth type in accordance with the tenth adversarial loss to acquire an updated discriminator of the fifth type.

In a possible embodiment of the present disclosure, the total loss of the to-be-trained generator may further include an average gradient loss. The second training sub-module is configured to train the to-be-trained generator, and when training the to-be-trained generator, the second training sub-module is further configured to: process the training image into to-be-repaired training images with N scales; input the to-be-repaired training images with the N scales to a to-be-trained generator and a previously-trained generator to acquire repair training images with the N scales; and calculate the average gradient loss of a repair training image with an N^{th} scale.

In a possible embodiment of the present disclosure, the average gradient loss AvgG may be calculated through

$$Avg G = \frac{1}{m \times n} {\sum }_{i = 1}^{m} {\sum }_{j = 1}^{n} {( ( {( \frac{\partial {f}_{i , j}}{\partial {x}_{i}} )}^{2} + {( \frac{\partial {f}_{i , j}}{\partial {y}_{i}} )}^{2} ) / 2 )}^{1 / 2} ,$$

where m and n represent a width and a height of the repair training image with the N^{th} scale respectively, and f_{i,j} represents a pixel at a position (i, j) in the repair training image with the N^{th} scale.

In a possible embodiment of the present disclosure, the first generator may include N repair modules, and the at least two discriminators may include discriminators of a first type with a structure different from N networks corresponding to the N repair modules. The training module may further include a third training sub-module. The third training sub-module is configured to train the to-be-trained generator, and when training the to-be-trained generator, the third training sub-module is further configured to: process the training image into to-be-repaired training images with N scales; extract landmarks in a to-be-repaired training image with each scale to generate a plurality of landmark heat maps, and merge and classify the landmark heat maps to acquire S landmark mask images with each scale, where S is an integer greater than or equal to 2; input the to-be-repaired training images with the N scales and the S landmark mask images with each scale to a to-be-trained generator or a previously-trained generator to acquire repair training images with the N scales; provide a repair training image with each scale with a truth-value label, and input the repair training image with the truth-value label to an initial discriminator of the first type or a previously-trained discriminator of the first type, so as to acquire a first discrimination result; calculate a first adversarial loss in accordance with the first discrimination result, a total adversarial loss including the first adversarial loss; and adjust a parameter of the to-be-trained generator or the previously-trained generator in accordance with the total adversarial loss.

The third training sub-module is configured to train the at least two discriminators, and when training the at least two discriminators, the third training sub-module is further configured to: process the training image into to-be-repaired training images with N scales, and process the authentication image into authentication images with N scales; extract landmarks in a to-be-repaired training image with each scale to generate a plurality of landmark heat maps, and merge and classify the landmark heat maps to acquire S landmark mask images with each scale; input the to-be-repaired training images with the N scales and the S landmark mask images with each scale to a to-be-trained generator or a previously-trained generator to acquire repair training images with the N scales; provide a repair training image with each scale with a false-value label, input the repair training image with the false-value label to an initial discriminator of the first type or a previously-trained discriminator of the first type so as to acquire a third discrimination result, provide an authentication image with each scale with a truth-value label, and input each authentication image with the truth-value label to a discriminator of the first type so as to acquire a fourth discrimination result; calculate a third adversarial loss in accordance with the third discrimination result and the fourth discrimination result; and adjust a parameter of each discriminator of the first type in accordance with the third adversarial loss to acquire an updated discriminator of the first type.

In a possible embodiment of the present disclosure, the first generator may include N repair modules. The third training sub-module is configured to train the to-be-trained generator, and when training the to-be-trained generator, the third training sub-module is further configured to: process the training image into to-be-repaired training images with N scales, and process the authentication image into authentication images with the N scales; input the to-be-repaired training images with the N scales to a to-be-trained generator and a previously-trained generator to acquire repair training images with the N scales; and input the repair training images with the N scales and the authentication images with the N scales to a VGG network to acquire a loss of the repair training image with each scale on M target layers of the VGG network, where M is an integer greater than or equal to 1. The first loss may include losses of the repair training images with the N scales on the M target layers.

In a possible embodiment of the present disclosure, the first loss may include a sum of values acquired through multiplying the loss of the repair training image with the each scale on the M target layers by a corresponding weight. The repair training images with different scales may have different weights on the target layers.

In a possible embodiment of the present disclosure, the first loss may further include a per-pixel norm 2 (L2) loss.

In a possible embodiment of the present disclosure, the first generator may include four repair modules with scales of 64*64, 128*128, 256*256 and 512*512 respectively.

In a possible embodiment of the present disclosure, S may be equal to 5, and the S landmark mask images may include landmark mask images about left eye, right eye, nose, mouth and contour.

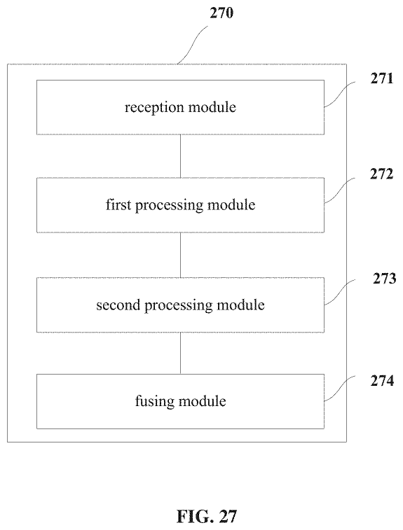

As shown in FIG. 27, the present disclosure further provides in some embodiments an image processing device, which includes: a reception module 271 configured to receive an input image; a face detection module 272 configured to detect a face in the input image to acquire a facial image; a first processing module configured to process the facial image using the above-mentioned method to acquire a first repair training image with definition higher than the input image; a second processing module 273 configured to process the input image or the input image without the facial image to acquire a second repair training image with definition higher than the input image; and a fusing module 274 configured to fuse the first repair training image with the second repair training image to acquire a fused image with definition higher than the input image.

In a possible embodiment of the present disclosure, the second processing module 273 is further configured to process the input image or the input image without the facial image using the above-mentioned image processing method to acquire the second repair training image.

The present disclosure further provides in some embodiments an electronic device, which includes a processor, a memory, and a program or instruction stored in the memory and executed by the processor. The program or instruction is executed by the processor so as to implement the steps of the abovementioned image processing methods.

The present disclosure further provides in some embodiments a computer-readable storage medium storing therein a program or instruction. The program or instruction is executed by a processor so as to implement the steps of the abovementioned image processing methods.

The processor may be a processor in the above-mentioned image processing device. The storage medium may include a computer-readable storage medium, e.g., Read-Only Memory (ROM), Random Access Memory (RAM), magnetic disk or optical disk.

It should be appreciated that, such terms as “include” or “including” or any other variations involved in the present disclosure intend to provide non-exclusive coverage, so that a procedure, method, article or device including a series of elements may also include any other elements not listed herein, or may include any inherent elements of the procedure, method, article or device. If without any further limitations, for the elements defined by such sentence as “including one . . . ”, it is not excluded that the procedure, method, article or device including the elements may also include any other identical elements. In addition, it should be further appreciated that, apart from the given or discussed order, the steps may also be performed simultaneously or in a reverse order, so as to achieve the mentioned functions. For example, the steps of the method may be performed in an order different from the described order, and new steps may be added, or some steps may be omitted or combined. In addition, the features described with reference to some embodiments may be combined in the other embodiments.

Through the above-mentioned description, it may be apparent for a person skilled in the art that the present disclosure may be implemented by software as well as a necessary common hardware platform, or by hardware, and the former may be better in most cases. Based on this, the technical solutions of the present disclosure, partial or full, or parts of the technical solutions of the present disclosure contributing to the related art, may appear in the form of software products, which may be stored in a storage medium (e.g., ROM/RAM, magnetic disk or optical disk) and include several instructions so as to enable a terminal device (mobile phone, computer, server, air conditioner or network device) to execute the method in the embodiments of the present disclosure.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. An image processing method, comprising:
receiving an input image; and
processing the input image through a first generator to acquire an output image with definition higher than the input image,
wherein the first generator is acquired through training a to-be-trained generator using at least two discriminators.

2. The image processing method according to claim 1, wherein the first generator comprises N repair modules, where N is an integer greater than or equal to 2, wherein the processing the input image through the first generator to acquire the output image comprises:
processing the input image into to-be-repaired images with N scales, the scales of a to-be-repaired image with a first scale to a to-be-repaired image with an N^{th} scale increasing gradually; and
acquiring the output image through the N repair modules in accordance with the to-be-repaired images with the N scales.

3. The image processing method according to claim 2, wherein in two adjacent scales in the N scales, the latter is twice the former.

4. The image processing method according to claim 2, wherein the processing the input image into the to-be-repaired images with the N scales comprises:
determining a scale range to which the input image belongs;
processing the input image into a to-be-repaired image with a j^{th} scale corresponding to the scale range to which the input image belongs, the i^{th} scale being one of the first scale to the N^{th} scale; and
upsampling and/or downsampling the to-be-repaired image with the j^{th} scale to acquire the other to-be-repaired images with N−1 scales.

5. The image processing method according to claim 2, wherein the acquiring the output image through the N repair modules in accordance with the to-be-repaired images with the N scales comprises:
splicing a to-be-repaired image with the first scale and a random noise image with the first scale to acquire a first spliced image, inputting the first spliced image to a first repair module to acquire a repaired image with the first scale, and upsampling the repaired image with the first scale to acquire an upsampled image with a second scale;
splicing an upsampled image with an i^{th} scale, a to-be-repaired image with the i^{th} scale and a random noise image with the i^{th} scale to acquire an i^{th} spliced image, inputting the i^{th} spliced image to an i^{th} repair module to acquire a repaired image with the i^{th} scale, and upsampling the repaired image with the i^{th} scale to acquire an upsampled image with an (i+1)^{th} scale, where i is an integer greater than or equal to 2; and
splicing an upsampled image with the N^{th} scale, a to-be-repaired image with the N^{th} scale and a random noise image with the N^{th} scale to acquire an N^{th} spliced image, and inputting the N^{th} spliced image to an N^{th} repair module to acquire a repaired image with the N^{th} scale as an output image of the first generator.

6. The image processing method according to claim 2, wherein the acquiring the output image through the N repair modules in accordance with the to-be-repaired images with the N scales comprises:
extracting landmarks in a to-be-repaired image with each scale to generate a plurality of landmark heat maps, and merging and classifying the landmark heat maps to acquire S landmark mask images with each scale, where S is an integer greater than or equal to 2;
splicing a to-be-repaired image with the first scale and S landmark mask images with the first scale to acquire a first spliced image, inputting the first spliced image to the first repair module to acquire a repaired image with the first scale, and upsampling the repaired image with the first scale to acquire an upsampled image with a second scale;
splicing an upsampled image with an i^{th} scale, a to-be-repaired image with the i^{th} scale and S landmark mask images with the i^{th} scale to acquire an i^{th} spliced image, inputting the i^{th} spliced image to an i^{th} repair module to acquire a repaired image with the i^{th} scale, and upsampling the repaired image with the i^{th} scale to acquire an upsampled image with an (i+1)^{th} scale, where i is an integer greater than or equal to 2; and
splicing an upsampled image with the N^{th} scale, a to-be-repaired image with the N^{th} scale and S landmark mask images with the N^{th} scale to acquire an N^{th} spliced image, and inputting the N^{th} spliced image to an N^{th} repair module to acquire a repaired image with the N^{th} scale as an output image of the first generator.

7. The image processing method according to claim 6, wherein the landmarks in the to-be-repaired image are extracted through a 4-stack hourglass model.

8. The image processing method according to claim 1, wherein when training the to-be-trained generator using the at least two discriminators to acquire the first generator, the to-be-trained generator and the at least two discriminators are trained alternately in accordance with a training image and an authentication image to acquire the first generator, wherein the authentication image has definition higher than the training image, and when training the to-be-trained generator, a total loss of the to-be-trained generator comprises at least one of a first loss and a total adversarial loss of the at least two discriminators.

9. The image processing method according to claim 8, wherein the first generator comprises N repair modules, where N is an integer greater than or equal to 2, wherein the at least two discriminators comprise discriminators of a first type with a structure different from N networks corresponding to the N repair modules, and discriminators of a second type configured to improve the local repairing of the definition of a face in the training image by the first generator.

10. The image processing method according to claim 9, wherein the training the to-be-trained generator comprises:
processing the training image into to-be-repaired training image with N scales;
inputting the to-be-repaired training images with the N scales to the to-be-trained generator or a previously-trained generator to acquire repair training images with the N scales;
acquiring a first local facial image in a repair training image with an N^{th} scale;
providing a repair training image with each scale with a truth-value label, and inputting the repair training image with the truth-value label to an initial discriminator of the first type or a previously-trained discriminator of the first type to acquire a first discrimination result;
providing the first local facial image with a truth-value label, and inputting the first local facial image with the truth-value label to an initial discriminator of the second type or a previously-trained discriminator of the second type to acquire a second discrimination result;
calculating a first adversarial loss in accordance with the first discrimination result and calculating a second adversarial loss in accordance with the second discrimination result, a total adversarial loss comprising the first adversarial loss and the second adversarial loss; and
adjusting a parameter of the to-be-trained generator or the previously-trained generator in accordance with the total adversarial loss,
wherein the training the at least two discriminators comprises:
processing the training image into to-be-repaired training images with N scales, and processing the authentication image into authentication images with N scales;
acquiring a second local facial image in an authentication image with an N^{th} scale;
inputting the to-be-repaired training images with the N scales to the to-be-trained generator or the previously-trained generator to acquire repair training images with the N scales;
acquiring the first local facial image in the repair training image with the N^{th} scale;
providing a repair training image with each scale with a false-value label, inputting the repair training image with the false-value label to the initial discriminator of the first type or the previously-trained discriminator of the first type to acquire a third discrimination result, providing an authentication image with each scale with a truth-value label, and inputting the authentication image with the truth-value label to each discriminator of the first type to acquire a fourth discrimination result;
providing the first local facial image with a false-value label, inputting the first local facial image with the false-value label to an initial discriminator of the second type or a previously-trained discriminator of the second type to acquire a fifth discrimination result, providing the second local facial image with a truth-value label, and inputting the second local facial image with the truth-value label to the initial discriminator of the second type or the previously-trained discriminator of the second type to acquire a sixth discrimination result;
calculating a third adversarial loss in accordance with the third discrimination result and the fourth discrimination result, and calculating a fourth adversarial loss in accordance with the fifth discrimination result and the sixth discrimination result; and
adjusting a parameter of each discriminator of the first type in accordance with the third adversarial loss to acquire an updated discriminator of the first type, and adjusting a parameter of each discriminator of the second type in accordance with the fourth adversarial loss to acquire an updated discriminator of the second type.

11. The image processing method according to claim 10, wherein the first local facial image and the second local facial image are each an eye image.

12. The image processing method according to claim 9, wherein the at least two discriminators further comprises X discriminators of a third type, where X is a positive integer greater than or equal to 1, and each discriminator of the third type is configured to improve the repairing of details of a facial component in the training image by the first generator.

13. The image processing method according to claim 12, wherein the training the to-be-trained generator further comprises:
processing the training image into to-be-repaired training images with N scales;
inputting the to-be-repaired training images with the N scales to the to-be-trained generator or a previously-trained generator to acquire repair training images with the N scales;
subjecting a repair training image with an N^{th} scale to face parsing treatment using a face parsing network to acquire X first facial component images corresponding to the repair training image with the N^{th} scale, the first facial component image comprising one facial component when X is equal to 1 and the X first facial component images comprising different facial components when X is greater than 1;
providing each of the X first facial component images with a truth-value label, and inputting each first facial component image with the truth-value label to an initial discriminator of the third type or a previously-trained discriminator of the third type to acquire a seventh discrimination result; and
calculating a fifth adversarial loss in accordance with the seventh discrimination result, a total adversarial loss comprising the fifth adversarial loss,
wherein the training the at least two discriminators comprises:
processing the training image into to-be-repaired training images with N scales, and processing the authentication image into authentication images with N scales;
inputting the to-be-repaired training images with the N scales to the to-be-trained generator or a previously-trained generator to acquire repair training images with the N scales;
subjecting a repair training image with an N^{th} scale to face parsing treatment using a face parsing network to acquire X first facial component images corresponding to the repair training image with the N^{th} scale, the X first facial component images comprising different facial components, and subjecting an authentication image with the N^{th} scale to face parsing treatment using the face parsing network to acquire X second facial component images corresponding to the authentication image with the N^{th} scale, the X second facial component images comprising different facial components;
providing each of the X first facial component images with a false-value label, inputting each first facial component image with the false-value label to an initial discriminator of the third type or a previously-trained discriminator of the third type to acquire an eighth discrimination result, providing each of the X second facial component images with a truth-value label, and inputting each second facial component image with the truth-value label to the initial discriminator of the third type or the previously-trained discriminator of the third type to acquire a ninth discrimination result;
calculating a sixth adversarial loss in accordance with the eight discrimination result and the ninth discrimination result; and
adjusting a parameter of each of the discriminators of the third type in accordance with the sixth adversarial loss to acquire an updated discriminator of the third type.

14. The image processing method according to claim 12 or 13, wherein X is equal to 1, and the discriminator of the third type is configured to improve the repairing of details of a facial skin in the training image by the first generator.

15. The image processing method according to claim 13, wherein the face parsing network is a semantic segmentation network.

16. The image processing method according to claim 9, wherein the total loss of the to-be-trained generator further comprises a face similarity loss, wherein the training the to-be-trained generator further comprises:
processing the training image into to-be-repaired training images with N scales;
inputting the to-be-repaired training images with the N scales to a to-be-trained generator or a previously-trained generator to acquire repair training images with the N scales;
subjecting a repair training image with an N^{th} scale to landmark detection through a landmark detection network, so as to acquire a first landmark heat map corresponding to the repair training image with the N^{th} scale;
subjecting the repair training image with the N^{th} scale to landmark detection through the landmark detection network, so as to acquire a second landmark heat map corresponding to the repair training image with the N^{th} scale; and
calculating the face similarity loss in accordance with the first landmark heat map and the second landmark heat map.

17. The image processing method according to claim 9, wherein the total loss of the to-be-trained generator further comprises an average gradient loss, wherein the training the to-be-trained generator further comprises:
processing the training image into to-be-repaired training images with N scales;
inputting the to-be-repaired training images with the N scales to a to-be-trained generator or a previously-trained generator to acquire repair training images with the N scales; and
calculating the average gradient loss of a repair training image with an N^{th} scale.

18. The image processing method according to claim 8, wherein the first generator comprises N repair modules having a same network structure, where N is an integer greater than or equal to 2;
a process for training the to-be-trained generator comprises a first training stage and a second training stage, and each of the first training stage and the second training stage comprises at least one process for training the to-be-trained generator;
at the first training stage, when adjusting a parameter of each repair module, all the repair modules share same parameters; and
at the second training stage, the parameter of each repair module is adjusted separately.

19. The image processing method according to claim 18, wherein a learning rate adopted at the first training stage is greater than a learning rate adopted at the second training stage.

20. The image processing method according to claim 8, wherein the at least two discriminators comprise discriminators of a fourth type and discriminators of a fifth type, each discriminator of the fourth type is configured to maintain a structural feature of the training image in the first generator, and each discriminator of the fifth type is configured to improve the repairing of details of the training image by the first generator.

21. The image processing method according to claim 20, wherein the training the to-be-trained generator comprises:
processing the training image into to-be-repaired training images with N scales;
inputting the to-be-repaired training images with the N scales to a to-be-trained generator or a previously-trained generator to acquire repair training images with the N scales;
providing a repair training image with each scale with a truth-value label, and inputting the repair training image with the truth-value label to an initial discriminator of the fourth type or a previously-trained discriminator of the fourth type to acquire a tenth discrimination result;
calculating a seventh adversarial loss in accordance with the tenth discrimination result;
providing a repair training image with each scale with a truth-value label, and inputting the repair training image with the truth-value label to an initial discriminator of the fifth type or a previously-trained discriminator of the fifth type to acquire an eleventh discrimination result;
calculating an eighth adversarial loss in accordance with the eleventh discrimination result, a total adversarial loss comprising the seventh adversarial loss and the eighth adversarial loss; and
adjusting a parameter of the to-be-trained generator or the previously-trained generator in accordance with the total adversarial loss,
wherein the training the at least two discriminators comprises:
processing the training image into to-be-repaired training images with N scales, and processing the authentication image into authentication images with N scales;
inputting the to-be-repaired training images with the N scales to a to-be-trained generator or a previously-trained generator to acquire repair training images with the N scales;
providing a repair training image with each scale with a false-value label, inputting the repair training image with the false-value label to an initial discriminator of the fourth type or a previously-trained discriminator of the fourth type to acquire a twelfth discrimination result, providing a to-be-repaired training image with each scale with a truth-value label, and inputting the to-be-repaired training image with the truth-value label to each discriminator of the fourth type or the previously-trained discriminator of the fourth type to acquire a thirteenth discrimination result;
calculating a ninth adversarial loss in accordance with the twelfth discrimination result and the thirteenth discrimination result;
adjusting a parameter of each discriminator of the fourth type in accordance with the ninth adversarial loss to acquire an updated discriminator of the fourth type;
subjecting the repair training image with each scale and the authentication image with a corresponding scale to high-frequency filtration, so as to acquire a filtered repair training image and a filtered authentication image;
providing a filtered repair training image with each scale with a false-value label, inputting the filtered repair training image with the false-value label to an initial discriminator of the fifth type or a previously-trained discriminator of the fifth type to acquire a fourteenth discrimination result, providing a filtered authentication image with each scale with a truth-value label, and inputting the filtered authentication image with the truth-value label to each discriminator of the fifth type or the previously-trained discriminator of the fifth type to acquire a fifteenth discrimination result;
calculating a tenth adversarial loss in accordance with the fourteenth discrimination result and the fifteenth discrimination result; and
adjusting a parameter of each discriminator of the fifth type in accordance with the tenth adversarial loss to acquire an updated discriminator of the fifth type.

22. The image processing method according to claim 20, wherein the total loss of the to-be-trained generator further comprises an average gradient loss, wherein the training the to-be-trained generator further comprises:
processing the training image into to-be-repaired training images with N scales;
inputting the to-be-repaired training images with the N scales to a to-be-trained generator and a previously-trained generator to acquire repair training images with the N scales; and
calculating the average gradient loss of a repair training image with an N^{th} scale.

23. The image processing method according to claim 17 or 22, wherein the average gradient loss AvgG is calculated through
$$Avg G = \frac{1}{m \times n} {\sum }_{i = 1}^{m} {\sum }_{j = 1}^{n} {( ( {( \frac{\partial {f}_{i , j}}{\partial {x}_{i}} )}^{2} + {( \frac{\partial {f}_{i , j}}{\partial {y}_{i}} )}^{2} ) / 2 )}^{1 / 2} ,$$
where m and n represent a width and a height of the repair training image with the N^{th} scale respectively, and f_{i,j} represents a pixel at a position (i, j) in the repair training image with the N^{th} scale.

24. The image processing method according to claim 8, wherein the first generator comprises N repair modules, and the at least two discriminators comprise discriminators of a first type with a structure different from N networks corresponding to the N repair modules, where N is an integer greater than or equal to 2.

25. The image processing method according to claim 24, wherein the training the to-be-trained generator comprises:
processing the training image into to-be-repaired training images with N scales;
extracting landmarks in a to-be-repaired training image with each scale to generate a plurality of landmark heat maps, and merging and classifying the landmark heat maps to acquire S landmark mask images with each scale, where S is an integer greater than or equal to 2;
inputting the to-be-repaired training images with the N scales and the S landmark mask images with each scale to a to-be-trained generator or a previously-trained generator to acquire repair training images with the N scales;
providing a repair training image with each scale with a truth-value label, and inputting the repair training image with the truth-value label to an initial discriminator of the first type or a previously-trained discriminator of the first type, so as to acquire a first discrimination result;
calculating a first adversarial loss in accordance with the first discrimination result, a total adversarial loss comprising the first adversarial loss; and
adjusting a parameter of the to-be-trained generator or the previously-trained generator in accordance with the total adversarial loss,
wherein the training the at least two discriminators comprises:
processing the training image into to-be-repaired training images with N scales, and processing the authentication image into authentication images with N scales;
extracting landmarks in a to-be-repaired training image with each scale to generate a plurality of landmark heat maps, and merge and classify the landmark heat maps to acquire S landmark mask images with each scale;
inputting the to-be-repaired training images with the N scales and the S landmark mask images with each scale to a to-be-trained generator or a previously-trained generator to acquire repair training images with the N scales;
providing a repair training image with each scale with a false-value label, inputting the repair training image with the false-value label to an initial discriminator of the first type or a previously-trained discriminator of the first type so as to acquire a third discrimination result, providing an authentication image with each scale with a truth-value label, and inputting each authentication image with the truth-value label to a discriminator of the first type so as to acquire a fourth discrimination result;
calculating a third adversarial loss in accordance with the third discrimination result and the fourth discrimination result; and
adjusting a parameter of each discriminator of the first type in accordance with the third adversarial loss to acquire an updated discriminator of the first type.

26. The image processing method according to claim 8 or 24, wherein the training the to-be-trained generator comprises:
processing the training image into to-be-repaired training images with N scales, and processing the authentication image into authentication images with the N scales;
inputting the to-be-repaired training images with the N scales to a to-be-trained generator and a previously-trained generator to acquire repair training images with the N scales; and
inputting the repair training images with the N scales and the authentication images with the N scales to a VGG network to acquire a loss of the repair training image with each scale on M target layers of the VGG network, where M is an integer greater than or equal to 1,
wherein the first loss comprises losses of the repair training images with the N scales on the M target layers.

27. The image processing method according to claim 26, wherein the first loss comprises a sum of values acquired through multiplying the loss of the repair training image with the each scale on the M target layers by a corresponding weight, and the repair training images with different scales have different weights on the target layers.

28. The image processing method according to claim 24, wherein the first loss further comprises a per-pixel norm 2 (L2) loss.

29. The image processing method according to claim 8, wherein the first loss further comprises at least one of an L1 loss, a second loss and a third loss,
wherein when the first loss comprise the L1 loss, the training the to-be-trained generator comprises:
processing the training image into to-be-repaired training images with N scales, and processing the authentication image into authentication images with the N scales;
inputting the to-be-repaired training images with the N scales to a to-be-trained generator and a previously-trained generator to acquire repair training images with the N scales; and
comparing the repair training images with the N scales with the authentication images with the N scales to acquire the L1 loss,
wherein when the first loss comprise the second loss, the training the to-be-trained generator comprises:
processing the training image into to-be-repaired training images with N scales, and processing the authentication image into authentication images with the N scales;
inputting the to-be-repaired training images with the N scales to a to-be-trained generator and a previously-trained generator to acquire repair training images with the N scales;
acquiring a first eye image in a repair training image with an N^{th} scale and a second eye image in an authentication image with the N^{th} scale; and
inputting the first eye image and the second eye image to a VGG network to acquire the second loss of the first eye image on M target layers of the VGG network, where M is an integer greater than or equal to 1,
wherein when the first loss comprise the third loss, the training the to-be-trained generator comprises:
processing the training image into to-be-repaired training images with N scales, and processing the authentication image into authentication images with the N scales;
inputting the to-be-repaired training images with the N scales to a to-be-trained generator and a previously-trained generator to acquire repair training images with the N scales;
acquiring a first facial skin image in a repair training image with an N^{th} scale and a second facial skin image in an authentication image with the N^{th} scale; and
inputting the first facial skin image and the second facial skin image to a VGG network to acquire the third loss of the first facial skin image on M target layers of the VGG network.

30. The image processing method according to claim 1, wherein the first generator comprises four repair modules with scales of 64*64, 128*128, 256*256 and 512*512 respectively.

31. The image processing method according to claim 6 or 25, wherein S is equal to 5, and the S landmark mask images comprises landmark mask images about left eye, right eye, nose, mouth and contour.

32. The image processing method according to claim 2, 5, 6, 9, 18 or 24, wherein a network structure adopted by each repair module is Super-Resolution Convolutional Neural Network (SRCNN) or U-Net.

33. An image processing method, comprising:
receiving an input image;
detecting a face in the input image to acquire a facial image;
processing the facial image using the image processing method according to any one of claims 1 to 32 to acquire a first repair training image with definition higher than the input image;
processing the input image or the input image without the facial image to acquire a second repair training image with definition higher than the input image; and
fusing the first repair training image with the second repair training image to acquire a fused image with definition higher than the input image.

34. The image processing method according to claim 33, wherein the processing the input image or the input image without the facial image to acquire the second repair training image comprises processing the input image or the input image without the facial image using the image processing method according to any one of claims 1 to 32 to acquire the second repair training image.

35. An image processing device, comprising:
a reception module configured to receive an input image; and
a processing module configured to process the input image through a first generator to acquire an output image with definition higher than the input image,
wherein the first generator is acquired through training a to-be-trained generator using at least two discriminators.

36. An image processing device, comprising:
a reception module configured to receive an input image;
a face detection module configured to detect a face in the input image to acquire a facial image;
a first processing module configured to process the facial image using the image processing method according to any one of claims 1 to 32 to acquire a first repair training image with definition higher than the input image; and
a second processing module configured to process the input image or the input image without the facial image to acquire a second repair training image with definition higher than the input image, and fuse the first repair training image with the second repair training image to acquire a fused image with definition higher than the input image.

37. An electronic device, comprising a processor, a memory, and a program or instruction stored in the memory and executed by the processor, wherein the processor is configured to execute the program or instruction so as to implement the steps of the image processing method according to any one of claims 1 to 32 or the steps of the image processing method according to claim 33 or 34.

38. A computer-readable storage medium storing therein a program or instruction, wherein the program or instruction is executed by a processor so as to implement the steps of the image processing method according to any one of claims 1 to 32 or the steps of the image processing method according to claim 33 or 34.
